(19) United States
(12) Patent Application Publication
(10) Pub. No.: US 2015/0060320 A1
(43) Pub. Date: Mar. 5, 2015

(54) LABELING OF ITEMS WITH WASH-OFF LABELS

(71) Applicant: UPM RAFLATAC OY, Tampere (FI)

(72) Inventors: Noel Mitchell, Wuppertal (DE); Kati Metsäjoki, Pirkkala (FI)

(21) Appl. No.: 14/382,143

(22) PCT Filed: Mar. 25, 2013
(86) PCT No.: PCT/FI2013/050333

§ 371 Date: Aug. 29, 2014

Related U.S. Application Data
(60) Provisional application No. 61/616,031, filed on Mar. 27, 2012.

(30) Foreign Application Priority Data
Mar. 27, 2012 (FI) 20125344

(51) Int. Cl. B65C 1/02; B32B 38/10; B65C 9/25; B32B 43/00; B65D 25/20; B65C 3/00

(52) U.S. Cl. CPC B65C 1/02; B65D 25/205; B65C 3/00; B65C 9/25; B32B 43/006; B32B 38/10; B32B 2309/02; B32B 2519/00
USPC 206/459.5; 156/273.3; 156/272.8; 156/85; 156/711

(57) ABSTRACT

A washable label may include a heat-shrinkable layer and a heat-activatable layer. The label may be attached to an item by a method including: heating a portion of the heat-activatable layer by intense visible or infrared light so as to transform the surface of the heat-activatable layer from a non-tacky state to a tacky state, and attaching the label to the item when the surface of the heat-activatable layer is in the tacky state, wherein the intensity of the light is selected such that spatially averaged temperature of the heat-shrinkable layer remains lower than the threshold shrinking temperature of the heat-shrinkable layer. The label may be easily separated from the item by heating the label such that shrinking of the heat-shrinkable layer peels at least a portion of the label away from the item.

### FIELD OF THE INVENTION

The present invention relates to labeling products.

### BACKGROUND

It is known to use self-adhesive labels for labeling products. Referring to FIG. 1, a typical self-adhesive label 90 comprises a facestock layer 91, a pressure-sensitive adhesive layer 92, and a release layer 99 laminated together. Self-adhesive labels are also called as pressure-sensitive adhesive (PSA) labels.

The self-adhesive label may be attached to an item by removing the release layer and pressing the exposed adhesive layer of the label on the surface of the item. The adhesive layer is tacky at the room temperature, and the release layer is needed to protect the adhesive layer against dirt, and in order to prevent accidental or premature adherence to items which should not be labeled.

### SUMMARY

An object of the present invention is to provide a method for labeling. An object of the present invention is to provide an apparatus for labeling. An object of the present invention is to provide a label. An object of the present invention is to provide a method for producing a label. An object of the present invention is to provide a labeled product. An object of the present invention is to provide a method for removing a label.

According to a first aspect of the invention, there is provided a method for attaching a label (100) to an item (ITE1), the label (100) comprising a heat-shrinkable layer (10) and a heat-activatable layer (20), wherein the activation temperature (T_{ACT}) of the heat activatable layer (20) is higher than the threshold shrinking temperature (T_{THR}) of the heat-shrinkable layer (10), wherein the method comprises:
heating a portion (21) of the heat-activatable layer (20) by visible or infrared light (LB1) so that at least a portion of the surface of the heat-activatable layer (20) is converted from a non-tacky state to a tacky state, and
attaching the label (100) to the item (ITE1) when the surface of the heat-activatable layer (20) is in the tacky state,
   wherein the intensity of the light (LB1) is selected such that the temperature (T₁₀) of a portion (11) of the heat-shrinkable layer (10) remains lower than the threshold shrinking temperature (T_{THR}) of the heat-shrinkable layer (10).

According to a second aspect of the invention, there is provided a combination of an item (ITE1) and label (100) attached to the item (ITE1), the label (100) comprising a heat-shrinkable layer (10) and a heat-activatable layer (20), wherein the activation temperature (T_{ACT}) of the heat-activatable layer (20) is higher than the threshold shrinking temperature (T_{THR}) of the heat-shrinkable layer (10), wherein the label (100) has been attached to the item (ITE1) by heating a portion (21) of the heat-activatable layer (20) by visible or infrared light (LB1) so that at least a portion of the surface of the heat-activatable layer (20) has been converted from a non-tacky state to a tacky state, wherein the intensity of the light (LB1) has been selected such that the temperature (T₁₀) of a portion (11) of the heat-shrinkable layer (10) has remained lower than the threshold shrinking temperature (T_{THR}) of the heat-shrinkable layer (10) during the heating.

According to a third aspect of the invention, there is provided a method of separating the label (100) from the item (ITE1), wherein the label (100) and the item (ITE1) form the combination according to any of the claims 8 to 11, the method comprising:
heating the label (100) to a temperature (T_{WASH}), which is higher than or equal to the threshold shrinking temperature (T_{THR}) of the heat-shrinkable layer (10), and which is higher than or equal to the activation temperature (T_{ACT}) of the heat-activatable layer (20).

Further embodiments of the invention are defined in the dependent claims.

The label comprises a heat-shrinkable layer and a heat-activatable layer.

The heat-shrinkable layer is arranged to shrink when heated above a predetermined temperature.

The heat-activatable layer may be converted from a non-tacky state to a tacky state by heating. The heat-activatable layer may be converted to its tacky state by heat prior to application to the surface of the item to be labeled. In the tacky state, the material of the heat-activatable layer may be brought into contact with the surface of the item. After contact with the surface, the heat-activatable layer may be cooled in order to form a stable bond between the heat-activatable layer and the surface of the item.

The combination of the heat-shrinkable layer and a heat-activatable layer facilitates removal of the label from a labeled item. This in turn may facilitate re-use or recycling of the item. The item may be e.g. a washable glass bottle.

The label may be adhered to the surface of the item by heating the heat-activatable layer such that it is transformed from non-tacky state to the tacky state. The label may be pressed after the heating on the surface of an item such that the heat-activatable layer is still in the tacky state. Upon subsequent cooling, a stable bond may be formed between the heat-activatable layer and the surface of the item. The heating and the pressing are preferably carried out so that the heat-shrinkable layer does not shrink to a significant degree. Thus, the label bonded to the item may still have a capability to shrink e.g. more than 20% of its original length.

The label may be later removed from the item by heating the label to a temperature which causes shrinking of the heat-shrinkable layer, and which also causes softening of the heat-activatable layer. In particular, the label may be removed by immersing it in a hot washing liquid.

When the label is heated, the heat-shrinkable layer begins to shrink generating a shear force in the bond. The bond may be simultaneously weakened due to softening of the heat-activatable adhesive such that the transverse force generated by the shrinking layer overcomes the adhesive force. Thus, shrinking of the heat-shrinkable layer may at least locally separate the label from the surface of the item.

Labels are typically removed from bottles by using a washing liquid. Thanks to the invention, the material layers of the label do not need to be permeable to the washing liquid. This in turn may provide a greater freedom to select the material layers of the label e.g. based on visual appearance, costs, recycling costs and/or effect on the environment.

The label may be used as a wash-off label. The label, the devices, and the methods described here may be used e.g. in the beverage industry. In an embodiment, recycling and/or reuse of bottles may be performed effectively, economically and in an environmentally friendly way. The label may be attached to and/or removed from a container, which may be e.g. a glass bottle, a plastic bottle, a metallic bottle, glass jar, or preserve can.

When using a washing liquid, it is not necessary to wait until the washing liquid penetrates through the layers of the label. Consequently, the rate of removing labels may be substantially increased.

The composition of the heat-activatable layer does not need to be soluble to the washing liquid. In an embodiment, the heat-activatable layer is not dissolved in the washing liquid, and the need for purifying or changing the washing liquid may be reduced.

The composition of the heat-shrinkable layer does not need to be soluble to the washing liquid. This may be an improvement when compared with e.g. to paper, which may become easily disintegrated in the washing liquid. In an embodiment, the heat-activatable layer is not dissolved in the washing liquid, and the need for purifying or changing the washing liquid may be reduced. Consequently, more labels may be removed by using the same amount of washing liquid.

The heat-activatable layer may be non-tacky at normal room temperatures. Thus, it is not necessary to use a release layer for protecting the heat-activatable layer. Thus, usage of materials needed for the labeling may be reduced. This may provide considerable savings in material and transport costs.

In an embodiment, visible or infrared light having a high energy density may be used for heating a thermally activatable adhesive of the bonding layer. Consequently, the total time needed for heating the label may be reduced. Thus, the overall energy consumption may be reduced, and/or the speed of attaching the labels to products may be increased. In particular, a laser beam may be used for heating the heat-activatable layer.

In an embodiment, the labeling rate by using the method may be e.g. more than 10000 items per hour, or even more than 50000 items per hour. The labeled items may be e.g. bottles. In particular, the labeled items may be glass bottles.

In an embodiment, the thickness of the carrier layer may be reduced and/or the carrier layer may be made of a material which has a lower softening temperature. Thus, the overall energy consumption may be reduced, and/or fewer materials may be consumed when producing the labels. Consequently, the production method of the labels may be more economical and/or environmentally friendly.

The use of a release liner may be avoided. Consequently, the amount of waste material may be reduced. The label may be stored, transported and/or used as a linerless label.

In an embodiment, the label may be handled and stored in a non-tacky state, and it may be converted to a tacky state just prior to bringing it into contact with the surface of the item to be labeled. This is an improvement over known pressure-sensitive labels. In particular, this is an improvement over wet-glue labels.

In an embodiment, the label does not need to completely surround an item. This may be an improvement over known shrink-sleeve labels.

In an embodiment, the label does not have visible seams. This may be an improvement over known wrap-around labels.

### BRIEF DESCRIPTION OF THE DRAWINGS

In the following examples, the embodiments of the invention will be described in more detail with reference to the appended drawings, in which

FIG. 1 shows, in a three-dimensional view, a known label comprising a release layer,

FIG. 2 shows, in a three-dimensional view, attaching a label to an item,

FIG. 3a shows, in a cross-sectional side view, a label attached to an item,

FIG. 3b shows, in a cross-sectional side view, the label of FIG. 3a after shrinking in hot washing liquid,

FIG. 3b shows, in a cross-sectional side view, the label of FIG. 3b after it has been fully separated from the item,

FIG. 4 shows, in a cross-sectional side view, applying adhesive material onto a carrier sheet so as to form the label,

FIG. 5a shows, in a cross-sectional side view, a label comprising a heat-shrinkable layer and a heat-activatable layer,

FIG. 5b shows, in a cross-sectional side view, a label of FIG. 5a after shrinking,

FIG. 6a shows, in a cross-sectional side view, activating the adhesive layer by heating it with light having a high intensity,

FIG. 6b shows, by way of example, temperature distribution in a label during heating,

FIG. 6c shows, by way of example, temperature distribution in the label immediately after equalization of temperatures,

FIG. 6d shows, in a cross-sectional side view, a portion of the heat-shrinkable layer and a portion of the heat-activatable layer, FIG. 6e shows, in a cross-sectional side view, bringing the activated adhesive layer of the label in contact with an item,

FIG. 6f shows, by way of example, temperature distribution in a label during heating,

FIG. 6g shows, by way of example, temperature distribution in a label during heating, wherein the label has an intermediate layer,

FIG. 7 shows steps of manufacturing a label, for attaching the label to an item, for using the item, and for separating the materials,

FIG. 8a shows, in a cross-sectional side view, a label comprising a heat-shrinkable layer, a heat-activatable layer, and at least one passive region,

FIG. 8b shows, in a cross-sectional side view, the label of FIG. 8a attached to an item,

FIG. 8c shows, in a cross-sectional side view, the label of FIG. 8b after shrinking in a hot washing liquid,

FIG. 9 shows, in a cross-sectional side view, a label comprising a heat-shrinkable layer, a thermally insulating layer, and a heat-activatable layer,

FIG. 10a shows, in a cross-sectional side view, a label comprising a heat-shrinkable layer, a compressive strain layer, and a heat-activatable layer,

FIG. 10b shows, in a cross-sectional side view, the label of FIG. 10a after shrinking,

FIG. 11 shows, in a cross-sectional side view, a label comprising a heat-shrinkable layer, a reflective layer, and a heat-activatable layer,

FIG. 12a shows, in a cross-sectional side view, an apparatus for attaching labels to items,

FIG. 12b shows, in three-dimensional view, the apparatus of FIG. 12a,

FIG. 13 shows, in a cross-sectional side view, changing the direction of a light beam with a reflector,

FIG. 14 shows, by way of example, spectral absorbance of the material layers,

FIG. 15 shows, by way of example, a shrinkage of a shrinkable material as a function of temperature,

FIG. 16 shows, by way of example, evolution of tack value for a heat-activatable adhesive, as a function of temperature, and

FIG. 17 shows, by way of example, evolution of tack and shrinkage as a function of temperature.

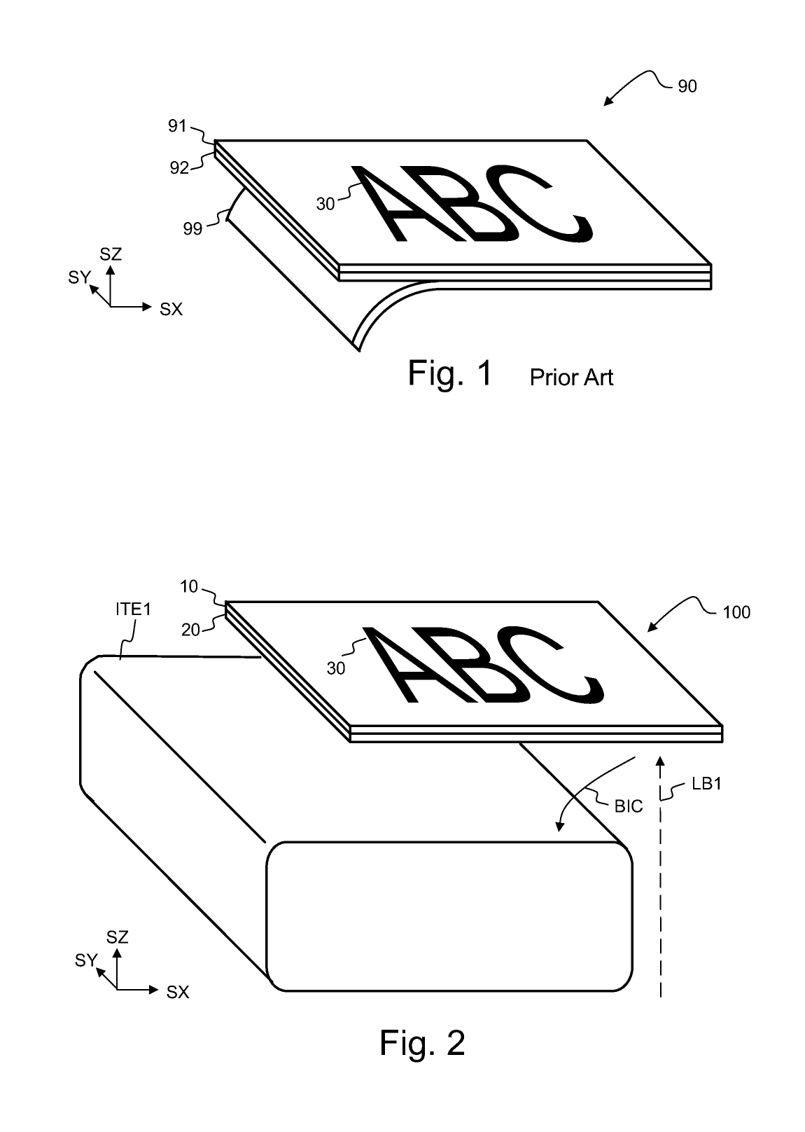

### DETAILED DESCRIPTION

Referring to FIG. 2, a label 100 may comprise a heat-shrinkable layer 10, and a heat-activatable adhesive layer 20. The label 100 may optionally comprise e.g. a graphical pattern 30 (e.g. a symbol “ABC”).

The heat-shrinkable layer 10 may be arranged to shrink when it is heated to a temperature which is higher than or equal to a threshold temperature T_{THR}.

The heat-activatable adhesive layer 20 of the label 100 may be converted from a non-tacky state to a tacky state by heating it to a temperature, which is higher than or equal to an activation temperature T_{ACT}. As the label may initially be non-tacky, it is not necessary to use a release layer 99. This, in turn, may reduce the consumption of materials.

The layer 20 may be heated by using high-intensity light LB1. The light may be e.g. visible light or infrared light. The light LB1 may be arranged to propagate as a light beam, which impinges on the layer 20. In particular, the beam LB1 may be a laser beam.

The label 100 may be attached to an item ITE1 by bringing the activated (tacky) layer 20 into contact with the surface of the item ITE1. BIC denotes “bringing into contact”.

The item ITE1 may be a container. In particular, the item ITE1 may be a glass bottle suitable for containing a beverage.

The heating and the attaching may be carried out such that the heat-shrinkable layer 10 does not yet shrink to a significant degree. The capability of the layer 10 to shrink may be utilized later when the label is removed from the item. The label 100 may be subsequently removed from the item ITE1 by heating the layer 10 such that it shrinks and peels at least a portion of the label 100 away from the item ITE1.In particular, the label 100 may be subsequently removed from the item ITE1 by heating both layers 10, 20 to a temperature, which is higher than or equal to the activation temperature T_{ACT} and higher than or equal to the threshold temperature T_{THR}. The material of the heat-activatable adhesive layer 20 may be selected such that when the layer 20 is heated, it may be softened such that the transverse (shear) force generated by the shrinking layer 10 can (at least locally) exceed the adhesive force between the layer 20 and the item ITE1.

The facestock layer (substrate layer) of the label 100 may comprise the heat-shrinkable layer 10. The facestock layer (substrate layer) of the label 100 may optionally comprise one or more further layers, in addition to the heat-shrinkable layer 10. However, the facestock layer (substrate layer) of the label 100 does not comprise the adhesive layer 20.

SX, SY and SZ denote orthogonal directions. The direction SZ may be parallel to the normal of the label 100

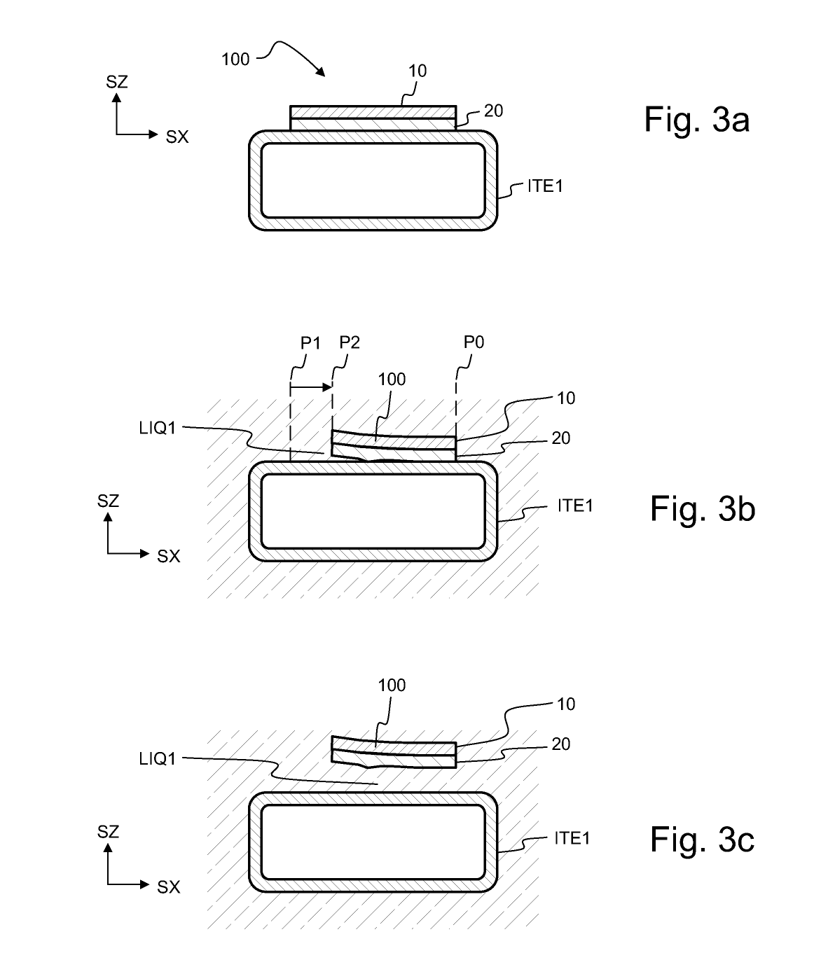

FIG. 3a shows a label 100 attached to an item ITE1. The heat-activatable adhesive material is in contact with the surface of the item ITE1. In particular, the heat-activatable adhesive material may be in direct contact with a glass surface of the item ITE1.

Referring to FIG. 3b, the heat-shrinkable layer 10 of the label 10 may shrink when the layers 10, 20 are heated. The shrinkable layer 10 may be under tensile stress when heated to or above the threshold temperature T_{THR}. The adhesive layer 20 may be softened and the bond between the adhesive layer 20 and the item ITE1 may become weaker when the adhesive layer 20 is heated. In particular, a pulling force generated by the shrinkable layer 10 may pull at least one edge of the label 100 such that at least one portion of the label 100 is separated from the item ITE1.

In particular, a gap may be formed between the adhesive layer 20 and the item ITE1. The washing liquid LIQ1 may subsequently penetrate into the gap, facilitating removal of the label 100. The washing liquid LIQ1 may also act as a lubricant and/or as an anti-adhesion agent.

Thanks to shrinking of the layer 10, immersing the labeled item ITE1 to heated washing liquid LIQ1 may be sufficient to completely separate the label 100 from the item ITE1.

However, removal of the label 100 from the item ITE1 may be optionally assisted by mechanical pulling, mechanical pushing, by scraping, by brushing and/or by using a liquid flow. In particular, a liquid flow may be directed to a gap formed between the label 100 and the item ITE1 so that the overpressure of the liquid in the gap separates the label away from the item ITE1.

FIG. 3c shows the label 100 of FIGS. 3a and 3b after it has been fully separated from the item ITE1.

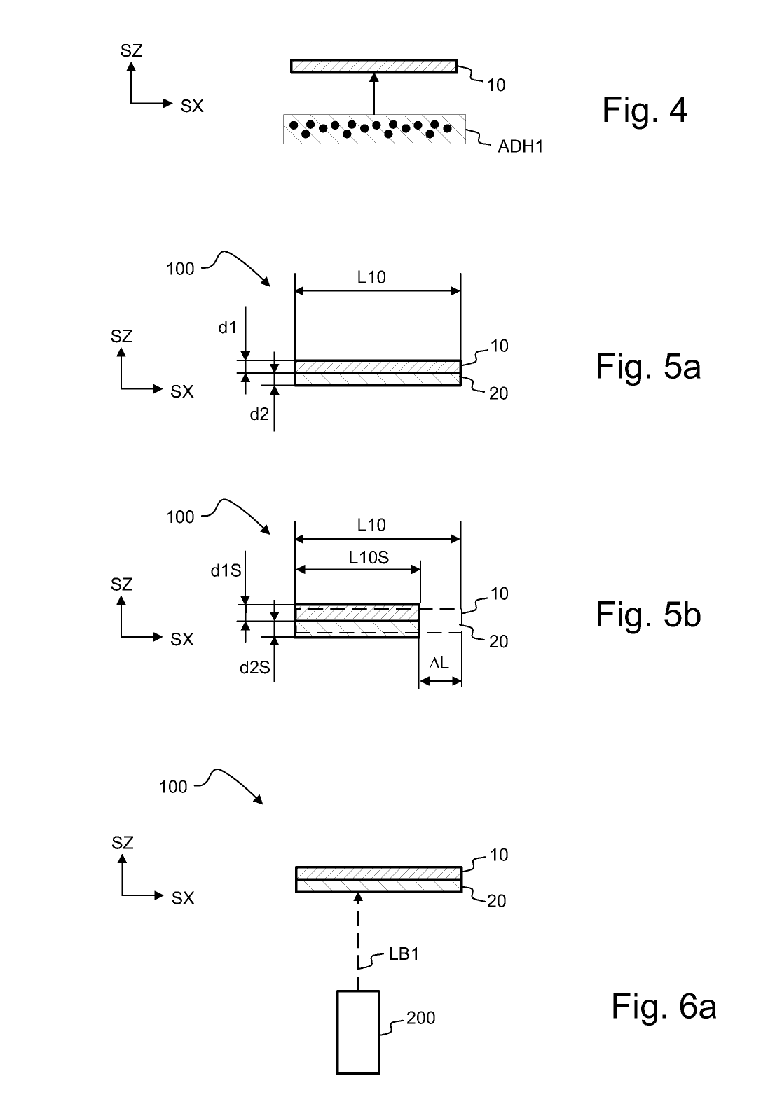

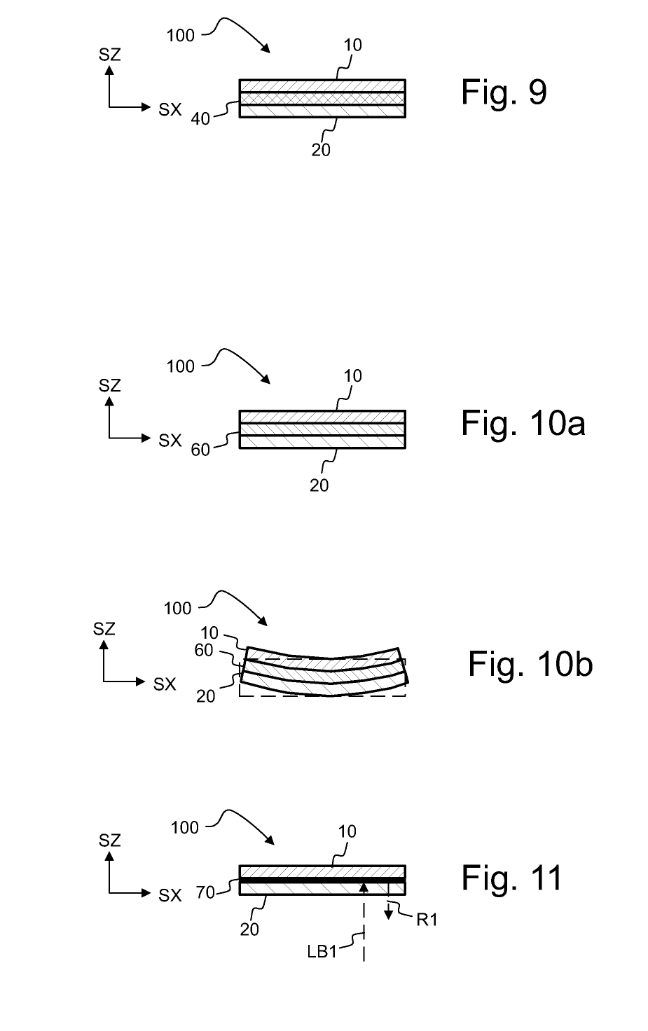

Referring to FIG. 4, the label 100 may be produced e.g. by combining a heat-shrinkable layer 10 with a heat-activatable adhesive ADH1. For example, a water-based dispersion of a heat-activatable adhesive ADH1 may be applied directly onto the heat-shrinkable layer 10 or onto an intermediate layer (See FIGS. 9-11). The dispersion may be subsequently dried at a temperature, which is lower than the threshold temperature T_{THR}.

FIG. 5a shows initial dimensions of the label 100. L10 denotes the initial length of the layer 10 in the direction SX prior to heating (i.e. before shrinking). d1 denotes the initial thickness of the shrinkable layer 10 before shrinking. d2 denotes the initial thickness of the adhesive layer 20 before shrinking. The thickness dl may be e.g. in the range of 0.01 mm to 1.0 mm, advantageously in the range of 0.02 to 0.2 mm. The thickness d2 may be e.g. in the range of 0.01 mm to 1.0 mm, advantageously in the range of 0.02 to 0.2 mm. The total thickness of the label 100 may be e.g. in the range of 0.02 to 2.0 mm, advantageously in the range of 0.02 to 0.10 mm. Consumption of materials may be reduced by using small thickness d1 and/or d2.

FIG. 5b shows dimensions of the label 100 after it has been shrunk by heating. L10S denotes the length of the layer 10 in the direction SX. AL denotes the change of length of the label 100. The change ΔL is equal to the difference L10-L10S. The unit of the change ΔL may be e.g. a millimeter. The relative change of length is equal to ΔL/L10. The relative change ΔL/L10 may also be called as the shrinkage. The unit of the relative change may be e.g. percentage (%).

When the layer 10 has not been (fully) shrunk, it may still have a capability to shrink. In that case, its shrinkage capability (heat-shrinkability) is equal to ΔL/L10. If the layer has been shrunk such that it does not have a capability to shrink any more, its shrinkage capability is zero.

d1S denotes the thickness of the shrinkable layer 10 after shrinking. d2S denotes the thickness of the adhesive layer 20 after shrinking. The thickness d1S may be greater than the thickness d1. The thickness d2S may be greater than the thickness d2. The increase of the thickness d1 and/or d2 may facilitate removal of the label.

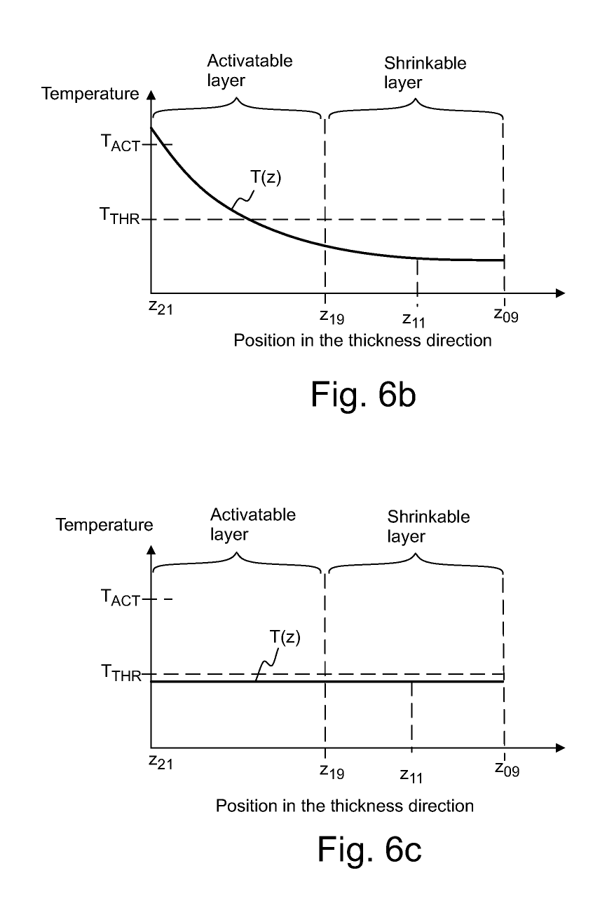

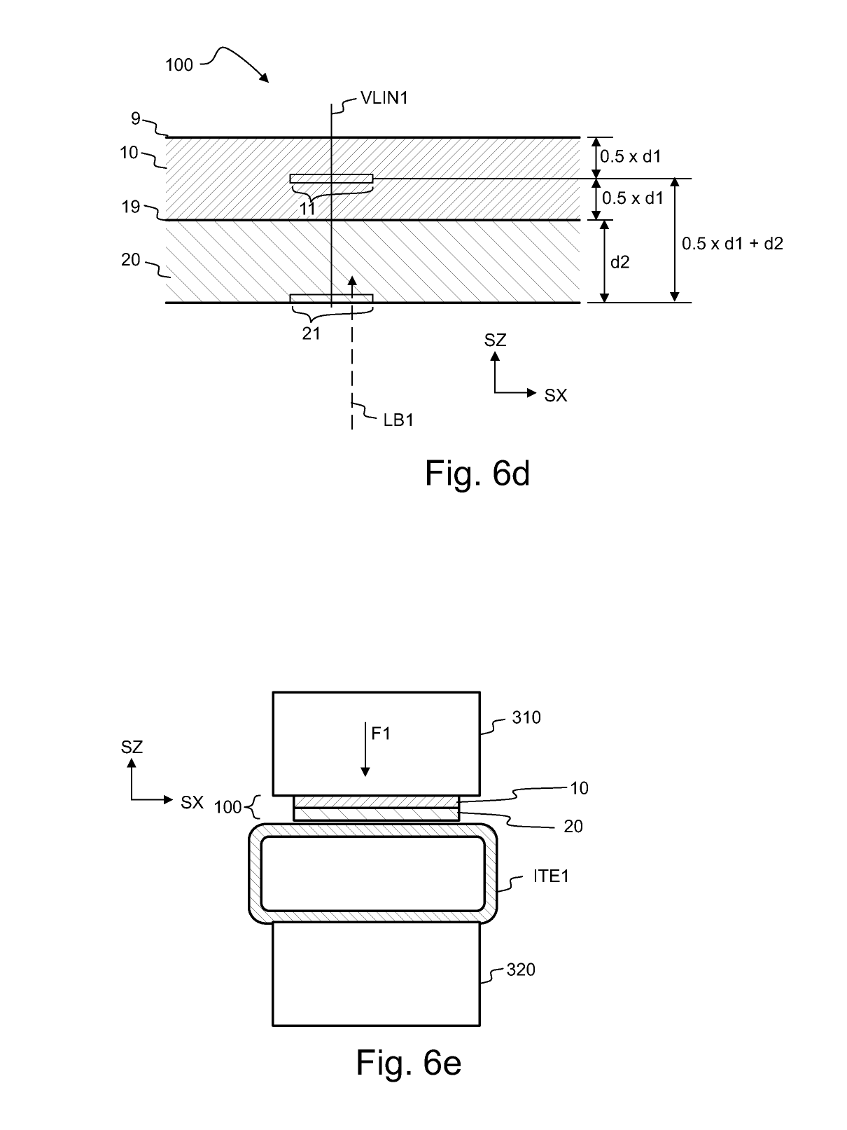

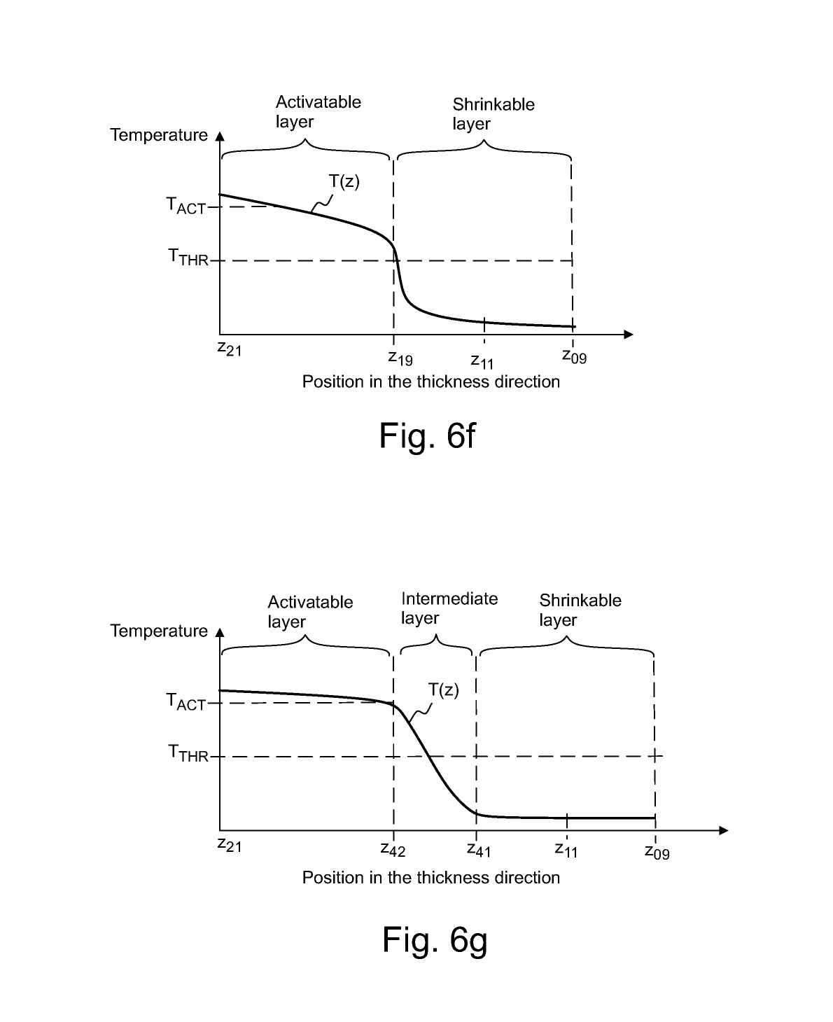

FIG. 6a shows activating the adhesive of the heat-activatable layer 20 by heating the layer 20 with the light LB1.

The light LB1 may be provided e.g. by a laser. In particular, a carbon dioxide (CO₂) laser may be used. The CO₂ laser may emit infrared light, which may have maximum spectral intensity at a wavelength, which is e.g. in the range of 9.4 μm to 10.6 μm. In particular, the carbon dioxide laser may be suitable for heating acrylic and/or polyurethane based adhesives.

The adhesive layer 20 may be heated such that the surface temperature T₂₀ of the adhesive layer 20 becomes at least momentarily higher than or equal to the activation temperature T_{ACT}, in order to convert the adhesive into the tacky state.

The adhesive layer 20 may be heated such that the surface temperature T₂₀ of the adhesive layer 20 becomes at least momentarily higher than or equal to the activation temperature T_{ACT}, wherein the vertically averaged temperature T₁₀ of the heat-shrinkable layer 10 may remain lower than the threshold temperature T_{THR}.

The adhesive layer 20 may be heated such that the difference T₂₀-T_{THR} between the surface temperature T₂₀ of the adhesive layer 20 and the threshold temperature T_{THR} is at least momentarily greater than or equal to 5° C., wherein the vertically averaged temperature T₁₀ of the heat-shrinkable layer may remain lower than the threshold temperature T_{THR}.

The higher temperature of the adhesive layer 20, when compared to the temperature of the shrinkable layer 10 may be attained e.g. by using one or more of the following:
The material of the layer 10 and/or the material of the layer 20 may be selected such that the absorbance of the layer 20 is higher than the absorbance of the layer 10 at the peak wavelength of the light LB1.
The wavelength of the light LB1 may be selected such that the absorbance of the layer 20 is higher than the absorbance of the layer 10 at the peak wavelength of the light LB1.
The layer 20 may comprise a light-absorbing dye such that the absorbance of the layer 20 is higher than the absorbance of the layer 10 at the peak wavelength of the light LB1.
The material of the layer 20, the thickness of the layer 20 and/or the wavelength of the light LB1 may be selected such that the portion of the power of the light LB1 absorbed in the layer 20 is substantially greater than 50%, advantageously greater than 70%, and preferably greater than 90% of the initial power of the light LB1.
The label 100 may comprise a reflective layer 70 (FIG. 11), which reflects a portion of the power of the light LB1 back to the layer 20. The reflective layer may be e.g. an aluminum layer. The reflective layer 70 may be positioned between the layers 10, 20.
The label 100 may comprise an intermediate layer 40 (FIG. 9) which decreases the heat conductivity from the layer 20 to the layer 10.

FIG. 6b shows, by way of example, temperature distribution across the label in the thickness direction during heating with the light LB1. The curve T(z) may represent temperatures on the line VLIN1 shown in FIG. 6d. For activation, it may be sufficient when the temperature of the exposed surface is at least momentarily higher than or equal to the activation temperature T_{ACT}.

The thickness direction SZ may also be called as the vertical direction. The label 100 may have any orientation with respect to the gravity, and the “vertical” direction SZ does not need to be parallel to the direction of gravity.

z₂₁ may denote the (vertical) position coordinate of the exposed surface of the adhesive layer 20. z₁₉ may denote the position coordinate of an interface 19 between the layers 10, 20. z₀₉ may denote the position coordinate of the upper surface of the shrinkable layer 10. z₁₁ may denote the position coordinate of an inner portion 11, which is located in the middle of the shrinkable layer 10.

FIG. 6c shows, by way of example, temperature distribution across the label after the heating has been stopped, and after the temperatures at different positions have been substantially equalized. During the equalization, thermal energy may be conducted from the adhesive layer 20 to the shrinkable layer 10. The vertically averaged temperature of the shrinkable layer 10 may remain lower than the threshold temperature T_{THR}.

The term “vertically averaged temperature” means the average value of temperatures at points of the layer 10 located on a line VLIN1 (FIG. 6d), which is perpendicular to the shrinkable layer 10. The vertically averaged temperature is associated with a certain longitudinal and transverse position defined by the position of said line (VLIN1). The directions SX and SY may define a “horizontal” plane, and the average temperature may be calculated along a “vertical” line (VLIN1), which is parallel to the direction SZ.

The light beam LB1 may be moved with respect to the label 100. When heating with a light beam, the whole surface of a label 100 does not need to be activated simultaneously. As the heating may be rapid, the layers 10 and 20 may have non-zero temperature gradients in the thickness direction (SZ). For that reason, it may be relevant to consider small portions of the layers 10, 20.

FIG. 6d shows in more detail a first portion 11 and a second portion 21 of the label 100. The first portion 11 may be located within the heat-shrinkable layer 10 such that the distance to the upper surface of the layer 10 is equal to the distance to the lower surface of the layer 10 (i.e. both distances are equal to 0.5·d1). To the first approximation, the temperature of the first portion may represent the vertically averaged temperature T₁₀ of the heat-shrinkable layer 10.

The dimension of the first portion 11 and the dimension of the second portion 21 in the direction SX may be e.g. equal to d1. The dimension of the first portion 11 and the dimension of the second portion 21 in the directions SY may be e.g. equal to d1. The heat-shrinkable layer 10 and the heat-activatable layer 20 may be joined together at an interface 19. The interface 19 may also be called as a boundary. The heat-shrinkable layer 10 may have an upper surface 9 such that the whole heat-shrinkable layer 10 is located between the upper surface 9 and the interface 19.

The second portion 21 may be located at the exposed (bottom) surface of the heat-activatable layer 20. The label 100 may become tacky when the exposed surface of the layer 20 becomes tacky. The temperature of the second portion may represent the temperature T₂₀ of exposed surface of the heat-activatable layer 20.

The intensity of the light LB1 when heating the adhesive layer 20 with the light LB1 may be selected such that the vertically averaged temperature T₁₀ of the heat-shrinkable layer 10 remains lower than the threshold shrinking temperature T_{THR} of the heat-shrinkable layer 10. In particular, the intensity of the light LB1 and the duration of heating the adhesive layer 20 with the light LB1 may be selected such that the vertically averaged temperature T₁₀ of the heat-shrinkable layer 10 remains lower than the threshold shrinking temperature T_{THR} of the heat-shrinkable layer 10.

Heating of the layer 20 may be carried out such that a difference T₂₀-T₁₀ between the temperature T₂₀ of the second portion 21 and the temperature T₁₀ of the first portion 11 at least instantaneously reaches a value which is greater than 5° C., wherein the temperature T₂₀ may at least instantaneously be greater than or equal to the activation temperature T_{ACT}, and the temperature T₁₀ may remain lower than the threshold temperature T_{THR}.

Heating of the layer 20 may be carried out such that the temperature T₁₀ of the first portion 11 remains substantially lower than the temperature T₂₀ of the second portion 21, during the whole time period between heating the portion 21 and pressing the portion 21 against the item ITE1.

A difference (T₂₀-T₁₀) between the temperature T₂₀ of the second portion 21 and the temperature T₁₀ of the first portion 11 may be e.g. greater than 5° C. when the temperature T₂₀ of the second portion 21 is equal to or higher than the activation temperature T_{ACT} of the adhesive of the heat-activatable layer 20.

In an embodiment, heating of the layer 20 may be carried out such that the temperature T₁₀ of the heat-shrinkable layer is substantially lower than the temperature T₂₀ of the heat-activatable layer 20, when the label 100 is brought into contact with the item ITE1. In an embodiment, the difference T₂₀-T₁₀ between the temperature T₂₀ of the second portion 21 and the temperature T₁₀ of the first portion 11 may also be greater than 5° C. when the second portion 21 is brought into contact with the surface of the item ITE1.

The portions 11, 21 may be overlapping. The portions 11, 21 may be overlapping such that the transverse position of the portions 11 coincides with the transverse position of the portion 21. The position of the portions 11, 21 may coincide with the position of the line VLIN1. The portions 11, 21 may be separated in the direction SZ by a non-zero distance 0.5·d1+d2.

The light LB1 may be coupled into the label 100 through the layer 20 (as shown in FIGS. 6a and 6d) or through the layer 10 (not shown).

Coupling of the light LB1 to the label 100 through the layer 20 may be advantageous because in this case the layer 10 may remain cooler and the layer 10 does not need to be transparent at the wavelength of the light LB1.

On the other hand, coupling of the light LB1 through the layer 10 to the layer 20 may be advantageous because this may allow minimizing the length of the time period between activating and contacting with the item ITE1. In fact, this may allow activating the layer 20 even when the layer 20 is already in contact with the surface of the item ITE1. In this case, the shrinkable layer 10 and all further layers may be at least locally transparent at the peak wavelength of the light LB1. The layer 10 may be opaque for visible light but transparent for infrared light LB1. The layer 10 may be transparent at visible and infrared light.

Referring to FIG. 6e, the label 100 may be brought into contact with an item ITE1 after the adhesive of the heat-activatable layer 20 has been activated by heat.

The label 100 may be pressed against the item ITE1 by using a pressure generated by a force F1.

The label 100 may be pressed onto the surface of the item ITE1 by holding the label 100 with a holding member 310, and by holding the item ITE1 with a holding member 320.

Once activated, the adhesive layer 20 may remain tacky during a certain time period even after the layer 20 has been cooled to a temperature, which is slightly lower than the activation temperature T_{ACT}. Said time period is called as the hot tack life. The hot tack life may be e.g. in the range of 0.1 s to 100 s. The label may be brought into contact with the item ITE1 within the hot tack life.

Heat may be rapidly conducted from the heated adhesive layer 20 to the shrinkable layer 10. Consequently, the temperatures T₁₀ and T₂₀ may be rapidly equalized after exposure to the heating light LB1 has been stopped. The time period for equalization of the temperatures may be e.g. in the range of 100 μs to 100 ms. The maximum value of the temperature T₁₀ during the heating and the initial value of the temperature T₂₀ just before the heating may be selected such that the vertically averaged temperature T₁₀ of the shrinkable layer 10 remains lower than the threshold temperature T_{THR} during and after the equalization. Thanks to the hot tack life, the adhesive layer 20 may remain tacky even after the equalization of the temperatures T₁₀, T₂₀ has taken place. Thus, a reliable bond between the label 100 and the item ITE1 may be formed even after the surface temperature of the adhesive layer 20 has decreased to a value lower than the activation temperature T_{ACT}.

FIG. 6b showed a situation where the optical depth of the activatable layer 20 is smaller than the geometrical thickness d2 of the layer 20 (at the wavelength of the light LB1). Consequently, the intensity of the light LB1 at the interface 19 may be substantially reduced when compared with the intensity of light LB1 impinging on the surface portion 21.

FIG. 6f shows, by way of example, a vertical temperature distribution in a label 100 during heating in a situation where the optical depth of the layer 20 is greater than the geometrical thickness d2 of the layer 20. Consequently, a region of the layer 20 near the interface 19 may be directly heated by the light LB1. Heat may be conducted from the layer 20 to the layer 10 such that the temperature of a thin region of the layer 10 in the vicinity of the interface 19 may exceed the threshold temperature T_{THR}. However, the vertically averaged temperature of the layer 10 may still remain lower than the threshold temperature T_{THR}. The material of the shrinkable layer 10 may be selected such that the optical absorbance of the shrinkable layer 10 is small, in order to minimize direct heating of the layer 10 by the light LB1.

FIG. 6g shows, by way of example, a vertical temperature distribution in a label 100 which has an intermediate thermally insulating layer (see e.g. FIG. 9). The intermediate layer may protect the shrinkable layer 10 from heat conducted from the adhesive layer 20. z₄₁ may denote the coordinate of a boundary between the shrinkable layer 10 and the thermally insulating intermediate layer. z₄₂ may denote the coordinate of a boundary between the adhesive layer 20 and the thermally insulating layer.

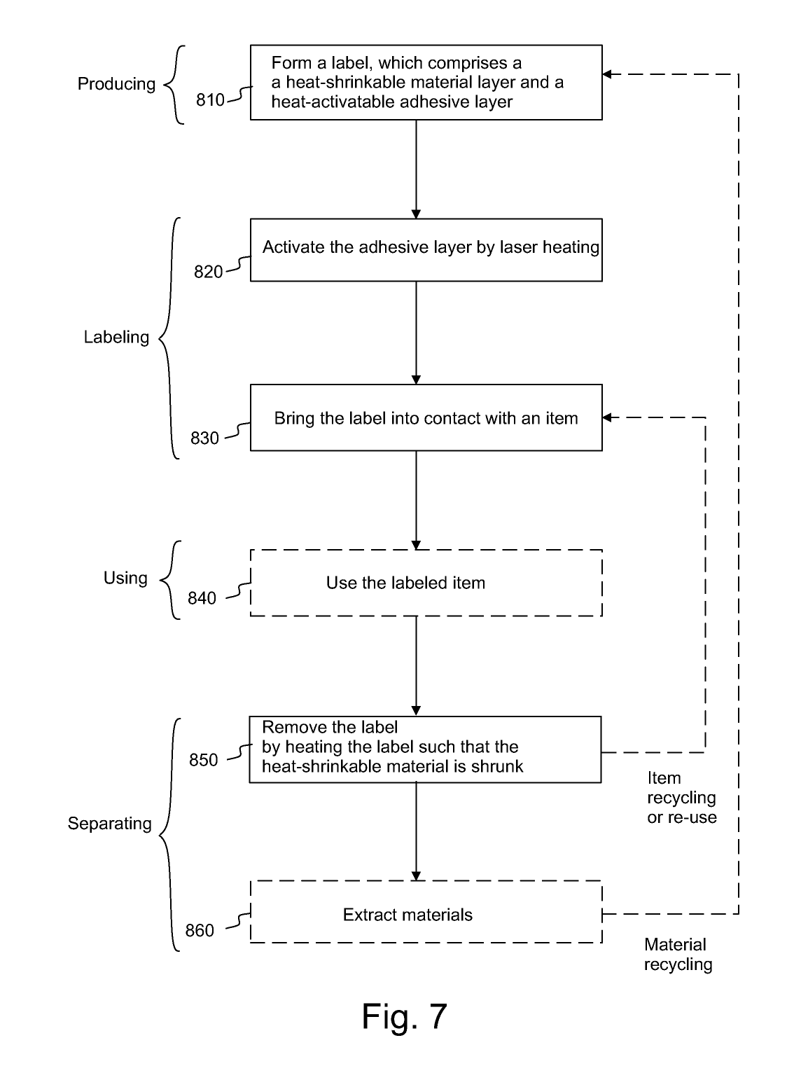

FIG. 7 shows phases of a lifecycle of a label 100. The label 100 may be produced, the label may be attached to an item to form a combination, the labeled item may be used, and the label may be separated from the item at the end of the lifecycle of the label.

The production of the label 100 may comprise a label forming step 810. The label 100 may be formed e.g. by applying an adhesive substance onto a heat-shrinkable layer 10. The adhesive substance may be e.g. a water-based dispersion. The adhesive substance may be applied e.g. by roller-coating, reverse-gravure, curtain-coating, spraying, dip-coating, and/or with a brush. Water may be evaporated from the dispersion by using e.g. hot air jets or infra-red heaters. The temperature of the layer 10 may be kept below the threshold temperature T_{THR} during the drying.

The label 100 may comprise one or more intermediate layers 40, 60, 70 located between the layers 10, 20 (See FIGS. 9-11). The adhesive substance may be applied onto directly onto the layer 10 or onto an intermediate layer.

A layer 10 comprising a heat-activatable material may be joined to a heat-shrinkable layer 10.

Several labels 100 may be initially produced as a web 101. The resulting web 101 may be wound into reels and supplied e.g. to a printer (e.g. for printing graphical patterns) for further processing. The web 101 may be stored and/or transported as a roll. The web 101 may be cut to form individual labels 100 at a later stage.

The heat-activatable layer 20 is preferably non-tacky in the normal room temperature (at temperatures below T_{ACT}). Thus, the layer 20 of the label 100 or of the web 101 does not need to be protected with a release liner (release layer 99).

A combination of an item ITE1 and the label 100 may be formed by a method comprising a heating step 820 and an attaching step 830. The exposed heat-activatable layer 20 may be activated by heating it with visible or infrared light having a high intensity.

In the attaching step 830, at least one portion of the heat-activatable layer 20 may be brought into contact with the surface of the item ITE1. The label 100 may be pressed against the item ITE1.

The (optional) using phase may comprise a using step 840, where the combination of the item ITE1 and the label 100 attached to the item ITE1 may be e.g. transported, stored, used for containing a beverage, delivered to a consumer, and/or collected back from a consumer. The item ITE1 may be e.g. a glass bottle, which is used to contain a beverage during a time period, which in the range of 1 hour to 1 year.

The separating phase may comprise a separating step 850 where the label 100 is heated to a temperature T_{WASH}, which is higher than or equal to the threshold shrinking temperature T_{THR} of the heat-shrinkable layer 10. Advantageously, the temperature T_{WASH} is also higher than or equal to the activation temperature T_{ACT} of the heat-activatable layer 20.

In particular, the label 100 may be heated by immersing it into a heated washing liquid LIQ1.

The item ITE1 may be optionally re-used after the label 100 has been removed. For example, a new label 100 may be attached to the item ITE1 and/or the item ITE1 may be re-filled with a new foodstuff or beverage.

The label 100 may be deformed or damaged in the removal step 850. However, the materials of the label 100 may be optionally recycled and utilized again.

Substantially the whole (one-sided) surface of the label 100 may be covered with a heat-activatable layer 20. The thickness d1 and/or d2 may be spatially constant.

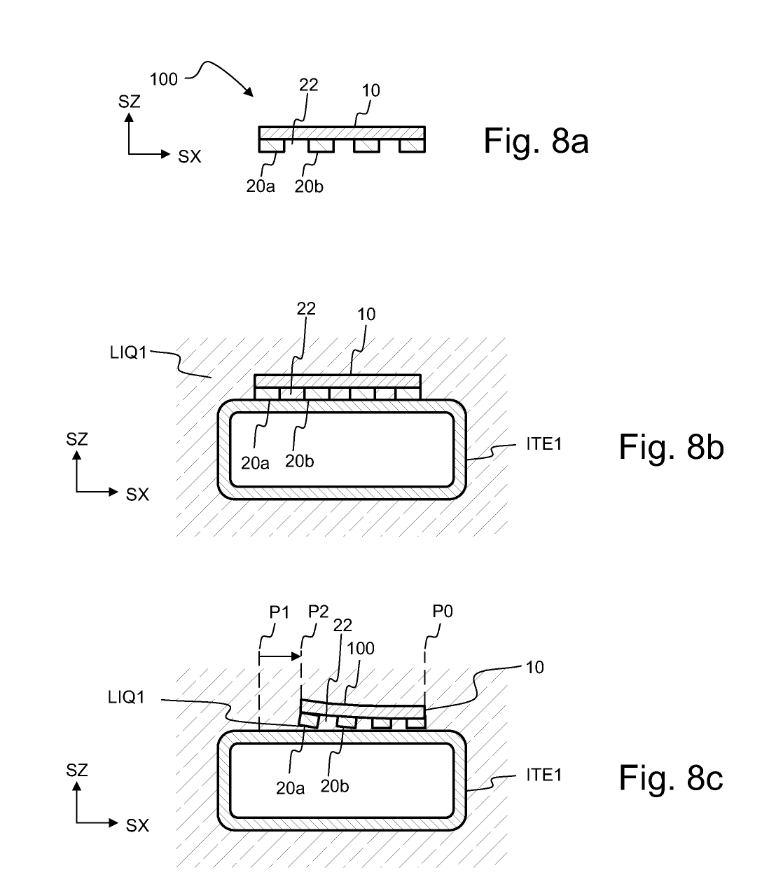

Referring to FIG. 8a, the thickness d1 of the shrinkable layer 10, the thickness d2 of the adhesive layer 20 and/or the thickness of an optional intermediate layer may be spatially varying in order to facilitate removal of the label 100. In particular, the thickness d2 may vary spatially between zero and a maximum value, as shown in FIG. 8a.

The adhesive may be applied as a single meandering stripe or a several separate stripes or spots such that one or more passive regions 22 remain between activatable regions 20a, 20b. Thus, the heat-activatable adhesive may cover substantially less than 100% of the bottom side of the label 100.

For example, the heat-activatable adhesive may cover an area which is in the range of 10% to 90% of the total one-sided area of the label 100.

Leaving one or more passive regions 22 between the activatable regions 20a, 20b may provide one or more of the following advantages:
consumption of the adhesive may be reduced,
the weight of the label 100 may be reduced,
the time and optical energy (of the light LB1) needed to activate the adhesive may be reduced,
the risk of premature shrinking may be reduced,
separation of the label may be facilitated
greater shrinkage may be attained, because a smaller force is needed to compress the activatable layer 20.

A spatially uniform adhesive layer or a patterned adhesive layer may be activated by using spatially uniform intensity distribution or spatially varying intensity distribution.

Substantially less than 100% of the bottom area of the label 100 may be heated by the light LB1. For example, the heated area may be in the range of 10% to 50% of the bottom area of the label 100, wherein 90% to 50% of the area is not directly heated. One or more stationary or moving light beams LB1 may be arranged to provide e.g. activated stripes or spots by locally heating a substantially continuous layer 20. Activated stripes or spots may also be provided by a mask, which locally prevents activation of certain areas of the layer 20.

The one or more light beams LB1 may provide a heating pattern that leaves certain one or more non-activated and thus non-adherent portions. The non-activated portions may form channels between the label and the item such that the washing liquid may subsequently penetrate quickly under the label from the peripheral regions of the label. This may accelerate removal of the label, in particular when the washing liquid LIQ1 reacts with the layer 20 or dissolves the layer 20. The permeability of one or more layers of the label may be low for the washing liquid, and the channels may accelerate wetting of the space between the label 100 and the item ITE1.

Referring to FIG. 8b, the combination of the item ITE1 and the label 100 may be immersed in a washing liquid LIQ1 in order to remove the label 100 at the end of the lifecycle of the label 100. The passive regions may form channels or cavities which facilitate penetration of the washing liquid LIQ1 to the space between the label 100 and the item ITE1. The liquid LIQ1 may rather easily moisten the surface of the item ITE1 in the vicinity of the passive region 22. In other words, a film of the liquid LIQ1 may be adhered to the surface of the item ITE1 in the vicinity of the passive region 22.

FIG. 8c shows the label 100 after shrinking. The liquid LIQ1 may rather easily moisten the surface of the item ITE1 in the vicinity of the passive region 22. In other words, a film of the liquid LIQ1 may be adhered to the surface of the item ITE1 in the vicinity of the passive region 22. When the label 100 shrinks and the portion 20a begins to slide over the surface of the item ITE1, the liquid film may remain in place, and the liquid film may act as a lubricant and as an anti-adhesion agent, which prevents re-attachment of the portion 20a back to the surface of the item ITE1.

The heat-activatable adhesive may be directly in contact with the heat-shrinkable material. In this case, the use of different types of materials may be minimized. On the other hand, the label 100 may comprise one or more additional layers.

Referring to FIG. 9, the label 100 may comprise a heat barrier layer 40 located between the layers 10, 20. The layer 40 may be arranged to protect the layer 10 from heat during the activation of the layer 20.

The heat barrier layer 40 may be thermally insulating. The layer 40 may be a thermally insulating layer 40. Thermal conductivity of the insulating layer 40 may be e.g. smaller than 0.1 W·m⁻¹K⁻¹. The layer 40 may comprise e.g. polymer foam.

The material of the intermediate layer 40 may also be selected to have a high heat capacity at a temperature, which is lower than the threshold temperature T_{THR}. A high capacity may be provided e.g. by a phase change (e.g. melting, softening and/or chemical reaction). The heat capacity may be e.g. greater than 2000 J/K⁻kg⁻¹ (J denotes Joule, K denotes Kelvin and kg denotes kilogram).

A portion of the heat-activatable layer 20 may itself operate as a heat barrier.

For example, the absorbance of the layer 20 may be so high and the irradiation time may be so short that only a thin film on the surface of the heat-activatable layer 20 is heated, wherein the remaining portion of the layer 20 located under the surface may operate as heat barrier. Temperature-dependent phase changes in the layer 20 may effectively reduce conduction of heat to the shrinkable layer 10. Thus, the use of different materials may be minimized and the manufacturing of the label may be simplified.

Referring to FIG. 10a, the label 100 may comprise a counter-force layer 60 located between the layers 10, 20. The shrinkage capability of the layer 60 may be substantially smaller than the shrinkage capability of the layer 10 at temperatures higher than or equal to the activation temperature T_{ACT}. Consequently, heating of the layer 10 together with the layer 60 may cause bending and/or buckling of the label 100 as shown in FIG. 10b, in order to facilitate removal of the label 100. The layer 60 may comprise e.g. paper or polymer. The polymer may be pre-shrunk and/or non-stretched such that it exhibits low shrinkage when heated.

Referring to FIG. 11, the label 100 may comprise a reflective layer 70 located between the layers 10, 20. The layer 70 may consist of e.g. metallic aluminum. The reflective layer 70 may prevent coupling of the light LB1 into the heat-shrinkable layer 10 and/or it may increase the intensity propagating in the heat-activatable layer 20.

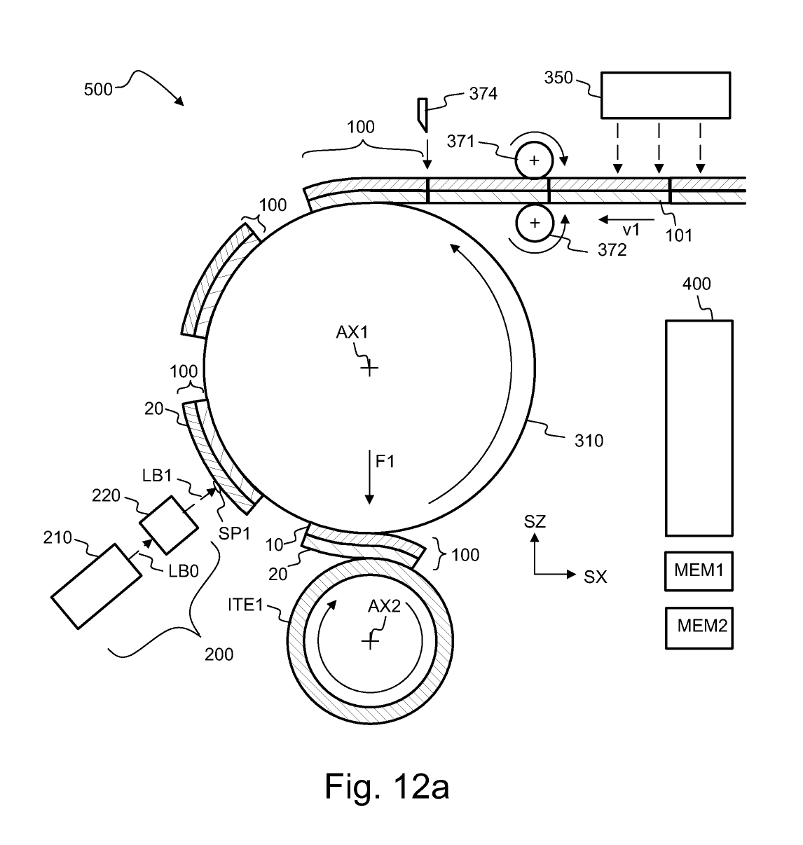

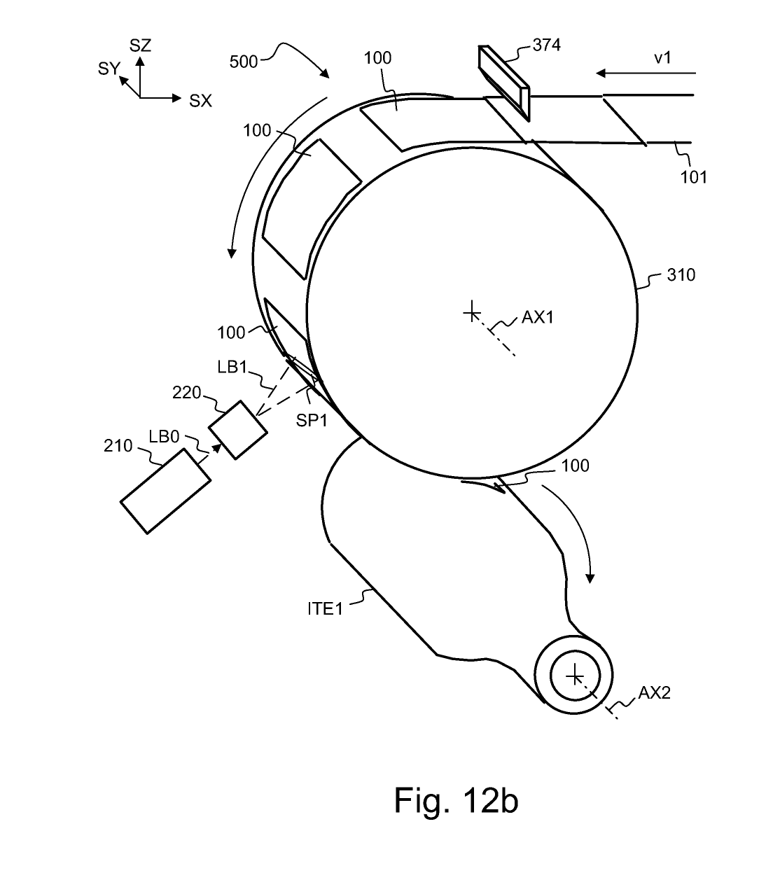

FIG. 12a shows an apparatus 500 arranged to attach a label 100 to an item ITE1. In particular, the apparatus 500 may be arranged to attach labels to a plurality of items at a high rate.

The label 100 may be held by a holding member 310. The holding member 310 may be e.g. a vacuum roll or a vacuum belt. The item ITE1 may held by a second member 320 (see e.g. FIG. 6e).

The member 310 may be moved with respect to the member 320, and/or the member 320 may be moved with respect to the member 310 in order to press the label 100 against the item ITE1. In particular, the members 310, 320 may be rotating members. The members 310, 320 may be arranged to move in synchronization with each other. The members 310, 320 may be arranged to rotate in synchronization with each other.

A light source 200 may be arranged to provide light LB1, which activates the adhesive of the heat-activatable layer 20 by heating. The light source 200 may comprise a light emitting unit 210 and a directing unit 220. The directing unit 220 may provide a light beam LB1 by changing the direction of a primary light beam LB0 and/or by changing the spatial properties of the primary light beam LB0. The primary light beam LB0 may be generated by the generating unit 210. In particular, the generating unit 210 may be a laser, and the light source 200 may be arranged to provide one or more laser beams LB1.

The light LB1 may impinge on the layer 20 at a (laser) spot SP1.

The directing unit 220 may comprise e.g. optics arranged to provide a suitable size and shape for the spot SP1. For example, the directing unit 220 may comprise optics arranged to distribute the power of the light beam LB1 to an area, whose dimension in the direction SY is close to the width of the label 100, in order to heat the entire width of the label.

For example, the directing unit 220 may comprise optics, which is arranged provide a scanning light beam LB1. The location of the spot SP1 may be moved e.g. in the direction SY in order to heat the entire width of the label.

The label 100 may be subsequently attached to an item ITE1 by bringing the activated surface of the layer 20 into contact with the item ITE1 and by pressing the label 100 against the item ITE1. The label and the item may be pressed together with a force F1.

Advantageously, the apparatus 500 may be arranged to operate such the heated and exposed (tacky) surface of the heat-activatable layer 20 is not touched by any other surface before it is pressed against the item ITE1.

The item ITE1 may be kept at a temperature, which is lower than the threshold temperature T_{THR} of the heat-shrinkable layer 10. Consequently, pressing the label 100 against the item ITE1 may facilitate cooling the heat-activatable layer 20 such that the risk of premature shrinking may be further reduced or avoided.

After a first item ITE1 has been labeled with a first label 100, the first item held by the member 320 may be replaced with a second item. The second item may be subsequently labeled with a second label, by using the apparatus 500.

The member 310 may be optionally rotated about an axis AX1. The item ITE1 may be optionally rotated about an axis AX2.

The item ITE1 may be optionally preheated to a temperature, which is higher than the normal room temperature 25° C., in order to improve andesion For example, the item ITE1 may be preheated to a temperature, which is in the range of 40° C. to 60° C. The apparatus 500 may comprise a heating unit for pre-heating the item ITE1.

The label 100 may be held against the member 310 e.g. by a pressure difference. The member 310 may comprise one or more holes (not shown) and/or the surface may be porous for extracting gas from a space between the label 100 and surface of the member 310. The gas may be extracted from said space e.g. by a pump (not shown), which creates a region of low pressure.

The labels 100 may be supplied separately or as a web 101. The web 101 may be fed at a (constant or varying) velocity v1. The apparatus 500 may optionally comprise e.g. one or more blades 374 to separate an individual label 100 from a web 101. The labels may be cut also by a laser beam.

The web 101 may be guided e.g. by one or more auxiliary (optional) rollers 371, 372.

The apparatus 500 may comprise e.g. pre-heater 350 to preheat a label 100. Preheating may allow the reduction of the intensity of the light LB1 and/or preheating may allow a high rate of attaching labels to items.

The apparatus 500 may comprise a control unit 400 arranged to control operation of the apparatus 500.

The apparatus may comprise a memory MEM1 for storing operating parameters of the apparatus. The operating parameters may comprise e.g. intensity of the light LB1, velocity of a label 100 with respect to a laser spot SP1, rotation speed of the member 310 (when the member 310 is a roll), preheat temperature of a label 100, temperature of the holding member, and temperature of the item ITE1.

The apparatus may comprise a memory MEM2 for storing computer program code which when executed by a processor is for controlling the operation of the apparatus 500 according to the invention.

The heat-activatable layer 20 may be heated to a temperature, which in a predetermined range. If the temperature is too low, a reliable bond will not be formed. If the temperature is too high, the layer 20 may be damaged and/or the heat-shrinkable layer 10 will begin to shrink. The state of the heat-activatable layer 20 may be monitored optically based on a change in the optical properties. For example, the state of the layer 20 may be monitored by monitoring light scattered from the surface of the bonding layer 20. For example, the surface may be smoother in the tacky state than in the non-tacky state. In the non-tacky state, the layer 20 may comprise microscopic grains or cracks, which may substantially disappear when the layer 20 is converted into the tacky state. Consequently, the surface may cause more diffuse reflection in the non-tacky state than in the tacky state. The activation time and/or power levels may be adjusted based on the monitored state of the layer 20. The activation time and/or power levels may be adjusted by using closed-loop control, in particular by using PID control.

FIG. 12b shows, in a three-dimensional view, the apparatus of FIG. 12a.

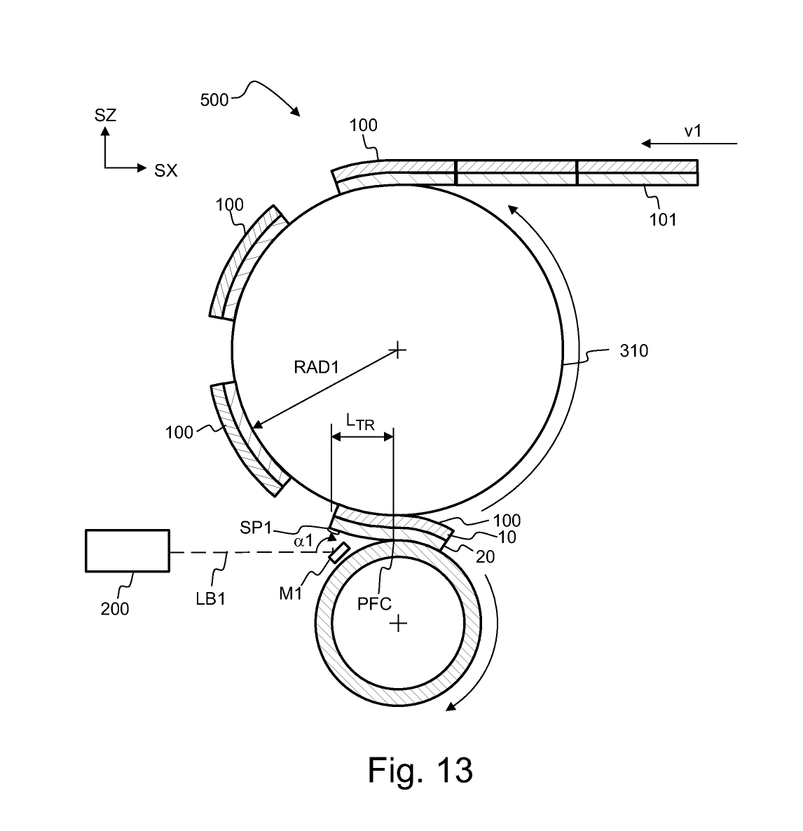

FIG. 13 shows how the distance L_{TR} between the (laser) spot SP1 and the point PFC of first contact may be reduced by using beam-directing optics M1. Consequently, the time delay between heating and attaching may be reduced.

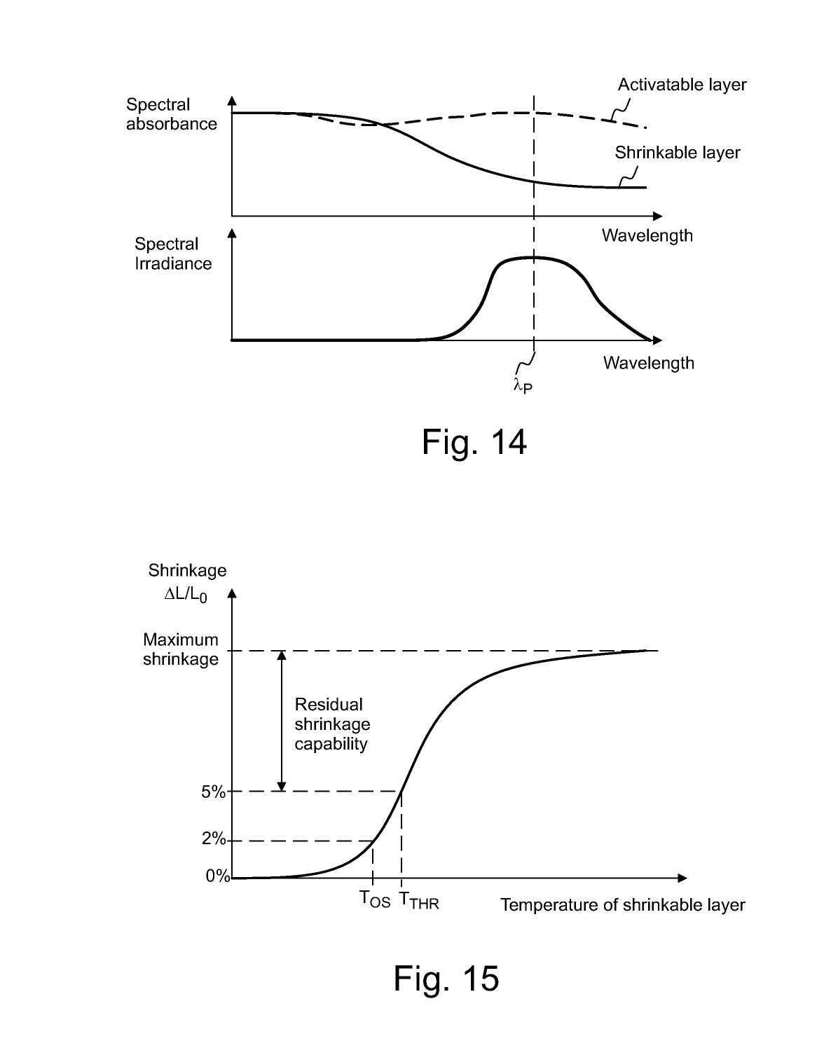

Referring to FIG. 14, the materials of the shrinkable layer 10 and/or the adhesive layer 20 may be selected such that the spectral absorbance of the adhesive layer 20 is higher than the spectral absorbance of the shrinkable layer 20 at the peak wavelength λ_{P} of the light LB1. Consequently, the shrinkable layer 20 may be heated less than the adhesive layer 20. The peak wavelength λ_{P} may be in the visible region or in the infrared region of electromagnetic radiation.

A dye may be added to the adhesive layer 20 in order to modify its spectral properties. For example, (black) carbon powder may be added to the adhesive layer 20.

However, it is not necessary to select the spectral properties according to FIG. 14. The thickness of the layer 20 and/or the material of the layer 20 may be selected such that most of the initial energy of the beam LB1 is absorbed already in the layer 20, before the beam LB1 impinges on the shrinkable layer 10. For example, the layer 20 may have so high absorbance at the wavelength of the beam LB1 that more than 70%, advantageously more than 90% of the initial energy of the beam LB1 may be absorbed in the adhesive layer 20.

FIG. 15 shows typical (relative) shrinkage ΔL/L₀ of heat-shrinkable material as a function of temperature. ΔL denotes a change of dimension (e.g. length), and L₀ denotes initial dimension (length). The threshold temperature T_{THR} may be defined to be a minimum temperature where the (relative) shrinkage ΔL/L₀ is greater than or equal to 5%. The threshold temperature T_{THR} may be defined to be a minimum temperature where the (relative) shrinkage ΔL/L₀ reaches 5%, when the temperature of the layer 10 is increased from a reference temperature of 25° C.

The shrinkable layer 10 may have residual shrinkage capability even after the layer 10 has been heated to the threshold temperature T_{THR}. The residual shrinkage capability may be utilized when the label is later removed by heating it in hot washing liquid LIQ1.

The (relative) shrinkage ΔL/L₀ of the layer 10, when heated from the threshold temperature T_{THR} to the activation temperature T_{ACT} may be e.g. greater than or equal to 5%, advantageously greater than or equal to 10%, and preferably greater than or equal to 20%.

The derivative of the curve of FIG. 15 may be called as the shrink rate. The maximum shrink rate at a temperature between the threshold temperature T_{THR} and the activation temperature T_{ACT} may be e.g. greater than or equal to 1%/° C., advantageously greater than or equal to 2%/° C., and preferably greater than or equal to 3%/° C.

The heat-shrinkable material may have an “on-set temperature” T_{OS}, which may be defined to be a minimum temperature where the (relative) shrinkage ΔL/L₀ is greater than or equal to 2%, when the temperature of the layer 10 is increased. The on-set temperature T_{OS} of the shrinkable layer 10 may be e.g. greater than or equal to 50° C. in order to minimize the risk of premature shrinking.

Advantageously, the intensity of the light LB1 may be selected such that the vertically averaged temperature T₁₀ of the heat-shrinkable layer 10 remains lower than the on-set temperature The. This may reduce shrinking of the label 100 during the attaching, to provide a visually pleasant appearance for the labeled item ITE1.

In an embodiment, amorphous adhesive material may be mixed with one or more other polymers such that the resulting composition is substantially non-tacky at the room temperature (i.e. at 25° C.). The resulting composition may be used as the adhesive layer 20 of the label 100, wherein said composition may become tacky when heated. In particular, the adhesive layer 20 may comprise amorphous polyurethane polymer blended with acrylic polymer and/or with styrene-acrylic polymer.

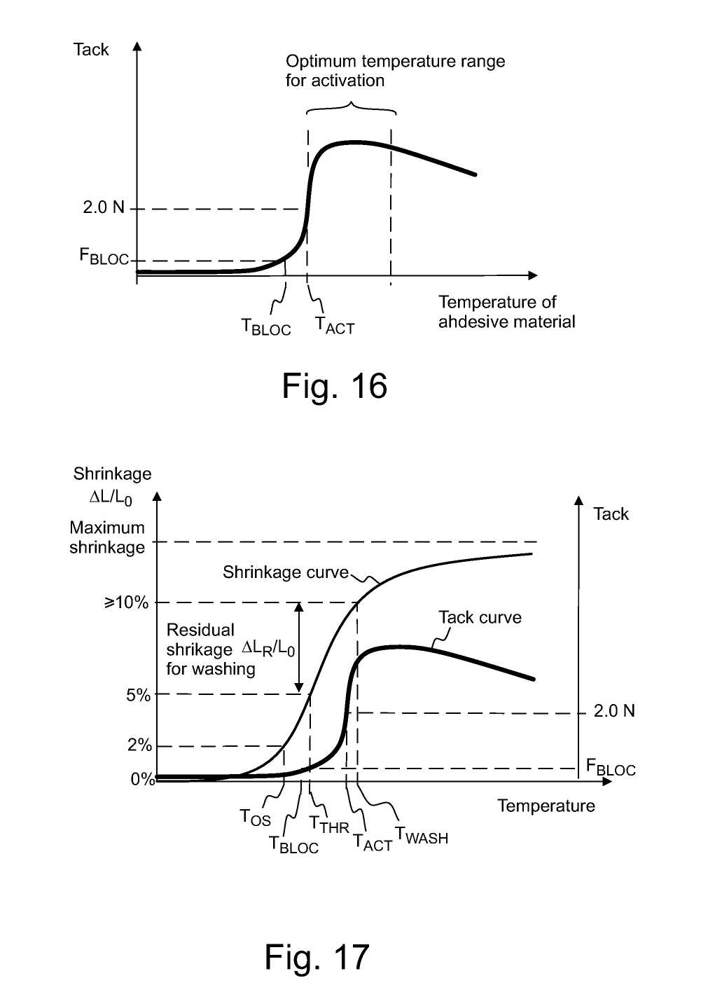

FIG. 16 shows typical behavior of tack values as a function of temperature. At a low temperature, the material of the heat-activatable layer 20 may be in the non-tacky state, and it may have a low tack value. At a high temperature, the heat-activatable layer may be in the tacky state, and it may have high tack value.

The activation temperature T_{ACT} may denote a temperature where the tack value is equal to 2.0 N, when the temperature of the layer 20 is increased. The activation temperature T_{ACT} may denote a temperature where the tack value reaches the value 2.0 N, when the temperature of the layer 20 is increased. The tack value may be measured by the standardized FINAT test method no. 9 (FTM9) “Quick Stick” tack measurement (loop tack), FINAT, Den Haag, Netherlands; (Class 1: test for adhesive tapes). Said loop tack test comprises measuring a force, which is needed to separate a loop strip from a base plate, such that the contact area is 25 mm×25 mm. The loop strip may be formed e.g. by cutting the test strip from a label 100.

During the activation, the surface temperature may at least momentarily reach or exceed the activation temperature T_{ACT}, Thus, the tack value utilized when attaching the label may be greater than or equal to 2.0 N. For a more reliable bond between the label and the item, the surface temperature may at least momentarily reach exceed the activation temperature T_{ACT} such that the momentary tack value is e.g. greater than 3 N, greater than 5 N, or even greater than 10 N.

In some cases, the loop tack value may depend on properties of the layer 20.

The activation temperature T_{ACT} may also be defined based on a probe tack value determined by the test method defined in the standard ASTM D2979, herein called as the probe test method. The probe tack value may be less dependent on the properties of the layer 20 than the loop tack value. The probe test method involves using a 5 mm diameter circular probe, and measuring the force needed to separate the probe from the adhesive layer.

The activation temperature T_{ACT} may denote a temperature where the probe tack value is equal to 0.4 N/mm².

During the activation, the surface temperature may at least momentarily reach or exceed the activation temperature T_{ACT}, Thus, the tack value utilized when attaching the label may be greater than or equal to 0.4 N/mm². For a more reliable bond between the label and the item, the surface temperature may at least momentarily reach exceed the activation temperature T_{ACT} such that the momentary tack value is e.g. greater than 0.6 N/mm², greater than 1.0 N/mm², or even greater than 2.0 N/mm².

The adhesive material may exhibit an increase in the tack value also at temperatures below the activation temperature T_{ACT}. This may be harmful when a plurality of labels are stored in a stack or in a roll. F_{BLOC} may denote a (minimum) tack value, which may cause problematic sticking of an adhesive layer of a first label 100 to the face surface of a second label 100. The sticking may be considered to be problematic e.g. when it causes an increased risk of damaging the labels when the labels are pulled apart. The tack value F_{BLOC} may be reached at a blocking temperature T_{BLOC}. Labels 100 stored in a roll may be “blocked” if the storage temperature is higher than or equal to the blocking temperature T_{BLOC}. The material of the activatable layer 20 may be selected such that the blocking temperature T_{BLOC} is higher than or equal to e.g. 50° C.

FIG. 17 shows, by way of example, the shrinkage and the tack as a function of temperature. Prior attaching to the item ITE1, the label 100 may be stored e.g. at temperatures below the on-set temperature T_{OS} and below the blocking temperature T_{BLOC} in order to reduce the risk of premature shrinking and to reduce the risk of premature sticking.

When the label 100 is attached to an item ITE1, the adhesive of the layer 20 may be activated by rapidly increasing the surface temperature of the layer 20 so that it is temporarily higher than or equal to the activation temperature T_{ACT}. The activation may be carried out by using the intense light LB1 such that the temperature of the shrinkable layer remains lower than the threshold temperature T_{THR}. This ensures that the label 100 may still have residual shrinkage capability, which can be utilized to facilitate removing the label 100 from the item ITE1. The shrinkage ΔL/L₀ of the layer 10, when heated to the washing temperature T_{WASH} may be e.g. greater than or equal to 10%. Before removal, the temperature of the shrinkable layer 10 has not exceeded the threshold temperature T_{THR}. The shrinkage ΔL/L₀ associated with the threshold temperature T_{THR} may be e.g. 5%. Thus, a residual shrinkage ΔL_{R}/L₀, which can be used to assist removal when the label 100 is heated to the washing temperature T_{WASH}, may be e.g. greater than or equal to 5%, advantageously greater than or equal to 10%, and preferably greater than or equal to 20%.

The materials of the layers 10, 20 may be selected such that the activation temperature T_{ACT} is lower than or equal to the washing temperature T_{WASH}, and such that the threshold temperature T_{THR} is lower than the activation temperature T_{ACT}. For a heat-activatable adhesive material, the activation temperature T_{ACT} and the blocking temperature T_{BLOC} may be coupled together such that selecting a high activation temperature T_{ACT} may also provide an elevated blocking temperature T_{BLOC}. The elevated blocking temperature T_{BLOC} may minimize the risk of premature adhesion to other labels. Furthermore, the material of the layer 10 may be selected such that heating the label 100 to the washing temperature T_{WASH} greater than or equal to the activation temperature T_{ACT} ensures sufficient residual shrinkage ΔL_{R}/L₀ (e.g. greater than or equal to 5%), in order to facilitate removal of the label.

The label 100 may be attached to an item e.g. in order to visually show information associated with the item. The information may comprise e.g. trademark of a manufacturer, advertising information, price information, or operating instructions.

The length of the label 100 (in direction SX) may be e.g. in the range of 1 cm to 20 cm, and the width of the label 100 (in direction SY) may be e.g. in the range of 0.5 cm to 10 cm.

The labeled item ITE1 may be a re-washable item, which can be labeled with a second label after removal of a first label.

The item ITE1 may be e.g. a recyclable or reusable container selected from a group consisting of a glass bottle, a plastic bottle, a plastic container, a glass container and a metallic container. The item ITE1 may be a re-washable container.

The item ITE1 may comprise or consist of e.g. glass, polyethylene terephthalate (PET) polycarbonate and/or stainless steel.

The item ITE1 may be a glass container, which can withstand several washing cycles in hot washing liquid without significant damage. The item ITE1 may be glass container for containing an edible substance. The glass bottle ITE1 may contain a beverage, e.g. milk, cream, beer, soft drink. The item ITE1 may be a glass jar comprising a food.

The threshold shrinking temperature T_{THR} may be e.g. lower than 95° C., which allows removal of the label 100 in aqueous washing liquid LIQ1 (at normal atmospheric pressure 100 kPa).

On the other hand It may be advantageous to select the threshold temperature T_{THR} to be high enough such that the label 100 is not accidentally removed e.g. when the labeled items is left in direct sunshine.

The threshold temperature T_{THR} may be e.g. higher than or equal to 60° C., higher than or equal to 70° C., or higher than or equal to 80° C.

The bond formed between the adhesive layer 20 and the item ITE1 should be soft at temperatures greater than or equal to the activation temperature T_{ACT}.

Advantageously, the adhesive layer 20 may be soft or it may become softer at temperatures greater than or equal to the activation temperature T_{ACT}. so that the transverse shear force generated by the shrinking layer 10 overcomes the force generated by the bond between the adhesive layer 20 and the item ITE1.

Activation of the adhesive layer 20 by the heat may be a reversible process. Heating of the heat-activatable layer 20 may reversibly transform the surface of the layer 20 from a non-tacky state to a tacky state. Subsequent cooling of the heat-activatable layer 20 may reversibly transform the surface of the layer 20 from a tacky state to a non-tacky state. A second heating of the heat-activatable layer 20 may reversibly transform the surface of the layer 20 from a non-tacky state to a tacky state, again.

Manufacturing of the label 100 may comprise drying an adhesive layer 20, which comprises a water-based dispersion. Manufacturing of the label 100 may comprise evaporating a solvent from an adhesive layer comprising solvent-based adhesive, said solvent being different from water. The drying and/or evaporation may comprise heating the label 100 to a temperature, which is lower than the threshold temperature T_{THR}. Manufacturing of the label 100 may comprise curing a solid adhesive by atmospheric moisture before heating the layer 20 to a temperature higher than or equal to the activation temperature T_{ACT}.

The composition of the adhesive layer 20 may be selected such that is not cured when heated to a temperature higher than or equal to the activation temperature T_{ACT}.

Advantageously, the activation temperature T_{ACT} is higher than or equal to the threshold temperature T_{THR}. Thus, the heated layer 10 will be under tensile strain and contraction of the label 100 in the hot washing liquid may take place almost immediately after the label 100 has been heated to the activation temperature T_{ACT}. The difference T_{ACT}-T_{THR} between the activation temperature T_{ACT} and the threshold temperature T_{THR} may be e.g. in the range of 5 to 30° C.

Selecting the activation temperature T_{ACT} to be higher than or equal to the threshold temperature T_{THR}. may allow using a more environmentally friendly combination of materials in the heat-activatable layer 20 and in the heat-shrinkable layer 10. This may allow larger variations in the properties of the heat-activatable layer 20 and in the heat-shrinkable layer 10. This may allow using cheaper materials in the heat-activatable layer 20 and in the heat-shrinkable layer 10. This may minimize the risk of premature activation of the adhesive layer 20 when a plurality of labels are stored for a long period in a roll or in a stack. The temperature of the labels may exceed 40° C., and sometimes even exceed 50° C. when stored and/or transported in a container, which is exposed to direct sunshine.

Heat-shrinkability is a quantitative property of a material. When the material has a heat-shrinkability which is equal to ΔL/L10, this means that the length of a body consisting of said material will change by an amount ΔL when the temperature of the body is increased from 25° C. to 100° C., the shrinking of the body is not mechanically restricted, and the initial length of the body (at 25° C.) is L10. The heat-shrinkability may also be called as the shrinkage capability.

The shrinkage capability ΔL/L10 of the material of the layer 10 in at least one direction (e.g. in the direction SX) may be e.g. greater than 10%, advantageously greater than 15%, and preferably greater than 20%.

The heat-shrinkable layer 10 may be mono-axially shrinkable or bi-axially shrinkable.

Typically, a higher shrinkage may be attained by mono-axial shrinking. The (mono-axial) shrinkage capability ΔL/L10 (see FIG. 5b) may be e.g. greater than 15%, advantageously greater than 20%, and preferably greater than 30%.

The heat-shrinkable layer 10 may be arranged to shrink substantially mono-axially in a first direction (e.g. in the direction SX), wherein the shrinkage in the second perpendicular direction (e.g. in the direction SY) may be smaller than 50% of the shrinkage in the first direction.

The label may be removed from the item by exposing the labeled item to a hot washing liquid LIQ1 such that the label is heated to a temperature which is higher than or equal to the activation temperature T_{ACT}. This causes softening of the adhesive layer 20. Furthermore, when the activation temperature T_{ACT} is higher than the threshold temperature T_{THR}, and when the shrinkable layer 10 still has at least the residual capability to shrink, the heating by the washing liquid LIQ1 may cause contraction of the layer 10 so as to facilitate removal of the label 100 from the item ITE1.

The activation temperature T_{ACT} may be greater than the threshold temperature T_{THR}, wherein the activation temperature T_{ACT} may be e.g. lower than or equal to 63° C., lower than or equal to 77° C., lower than or equal to 80° C., lower than or equal to 90° C., lower than or equal to 100° C., lower than or equal to 110° C., lower than or equal to 120° C.

The typical washing temperature T_{WASH} used in North America may be e.g. about 66° C. When the activation temperature T_{ACT} is selected to be lower than or equal to 63° C., this may allow removal of the label 100 by using a washing temperature T_{WASH} of 66° C. The typical washing temperature T_{WASH} used in Europe may be e.g. about 80° C. When the activation temperature T_{ACT} is selected to be lower than or equal to 77° C., this may allow removal of the label 100 by using a washing temperature T_{WASH} of 80° C.

A large difference T_{ACT}-T_{THR} between the activation temperature T_{ACT} and the threshold temperature T_{THR} may provide large shrinkage of the layer 10 when exposed to a washing temperature T_{WASH}, which is higher than or equal to the activation temperature T_{ACT}. On the other hand, the threshold temperature T_{THR} may be selected to be higher than or equal to e.g. 58° C. in order to reduce the risk of premature shrinking. For the typical North American washing conditions, the difference T_{ACT}-T_{THR} may be e.g. about 5° C. (=63° C.-58° C.). For the typical European washing conditions, the difference T_{ACT}-T_{THR} may be e.g. about 19° C. (=77° C.-58° C.).

The threshold temperature T_{THR} may be e.g. in the range of 58 to 75° C., and the difference T_{ACT}-T_{THR} between the activation temperature T_{ACT} and the threshold temperature T_{THR} may be e.g. in the range of 5 to 30° C.

When the label 100 is attached to the item ITE1, the adhesive layer 20 may be heated such that the heat-shrinkable layer 10 does not shrink to a significant degree. In particular, the label 100 may be heated such that the shrinkage ΔL/L10 which actually takes place is smaller than 5%, preferably smaller than 2%.

The adhesive material of the heat-activatable layer 20 may be selected e.g. such that the heat-activatable layer 20 is not tacky at temperatures below 50° C. The composition of the heat-activatable layer 20 is advantageously selected such that the layer 20 does not exhibit tackiness and/or a blocking tendency at temperatures below 50° C. Thus, the adhesive layer 20 does not need to be protected by a release layer during storage and/or transportation. The adhesive layer 20 does not need to be protected by a release layer even when a plurality of labels are stored and/or transported in a roll. Advantageously, the label 100 does not comprise a release layer. Advantageously, a first label of a roll of labels does not comprise a release layer arranged to be between the first label and a second label of said roll.

The heat-shrinkable layer 10 may comprise e.g. material selected from the following group: polyethylene terephthalate (PET), glykol-modified polyethylene terephtalate (PETG) polyvinylchloride (PVC), polyester, polystyrene, polyethylene, polypropene, polyoefin, cyclicolefin copolymer, and polyactic acid (PLA). The layer 10 may comprise two or more materials selected from this group.

The heat-activatable adhesive layer 20 may comprise e.g. material selected from the following group: polyurethane, acrylic, styrenic polymer, block-copolymer rubber, styrene-isoprene-styrene, styrene-butadiene, olefin-block copolymer, natural rubber, acrylic copolymer, hydrocarbon resin, and rosin ester. The layer 10 may comprise two or more materials selected from this group.

In particular, the heat-activatable adhesive layer 20 may comprise e.g.

polyurethane adhesive. The heat-shrinkable layer 10 may comprise e.g. polyethylene terephthalate (PET).

The graphical pattern 30 of the label 100 may be optionally protected with a transparent protective layer (not shown). The label may optionally comprise e.g. a thermally insulating layer 60 (FIG. 9) and/or a reflective layer 70 (FIG. 11).

A typical bottle recycling system may be arranged to use hot washing liquid LIQ1 for removing the labels 100. The layers 10, 20 may be heated e.g. by immersing the combination of the item ITE1 and the label 100 in a washing liquid LIQ1 FIG. 3b).

However, the layers 10, 20 may be heated also by heating in an oven or by to heating with a hot gas stream, instead or in addition to the washing liquid.

The heat-shrinkable layer 10 may comprise mono-axially oriented or biaxially oriented polymer film, which may comprise e.g. polyester, in particular polyethylene terephthalate (PET), polyvinylchloride and/or polypropylene. Typically, higher shrinkage and consequently slightly better removal properties may be obtained by using mono-axially oriented polymer film.

The layer 20 may comprise e.g. thermally activatable polyurethane. The adhesive layer 20 may comprise amorphous polyurethane polymer blended with acrylic polymer and/or with styrene-acrylic polymer such that the layer 20 is not tacky at the room temperature. After applying and drying the adhesive to a substrate (e.g. to the layer 10), a non-tacky activatable adhesive film may be first obtained. The activatable film may become tacky by heating the film to a temperature which is higher than or equal to the activation temperature. In particular, the polyurethane may comprise polyester segments and/or polyether segments, and the activation may comprise softening of the segments.

At temperatures below T_{ACT}, the layer 20 may be in a crystalline state, and the adhesive may be in the non-tacky state. At elevated temperatures, the layer 20 may become tacky. When the activation temperature exceeds an upper limit, the tack value may start to decrease due increased softening of the layer 20.

The time period during which the layer 20 has sufficient tackiness for bonding is called the hot-tack life. During this period, the adhesive may be tacky, and it may be joined to the surface of the item ITE1.

The hot-tack life may range e.g. from seconds to several minutes depending on the structure and chemical composition of the layer 20.

High initial bond strength may be obtained after a short time, by cooling of the adhesive film and reversible crystallization of polymer segments.

A property of heat-activatable polyurethane adhesives comprising the segments may be that, because of their high molecular weight and segmented polymer structure, the layer 20 may be mechanically stable at temperatures which are higher than the decrystallization (softening/melting) temperature of the segments. Thus, the layer 20 may exhibit thermoplastic flow to a considerable extent only at temperatures which are significantly higher than the minimum activation temperature T_{ACT}.

Acrylic and polyurethane adhesives may be thermally activated when the molecules of the adhesive gain enough thermal energy to overcome a threshold energy of activation. Thermal energy may induce a phase transition from the solid and tack free crystalline molecular structure of the adhesive to an amorphous tacky state.

The adhesive layer 20 may comprise an adhesive composition containing at least one acrylate polymer and at least one amorphous polyurethane or polyurethane-polyurea polymer. The adhesive composition may be applied onto the one or more other layers 10, 40, 60, 70 as an aqueous dispersion. The glass transition temperature of the acrylate polymer may be e.g. in the range of 50 to 90° C., and the glass transition temperature of the polyurethane or polyurethane-polyurea polymer may be e.g. in the range of −50 to 10° C. Adhesive compositions containing acrylate polymer and amorphous polyurethane or polyurethane-polyurea polymer have been described e.g. in EP2395064A1.

The heat-activatable layer 20 will be in contact with the surface of the item ITE1. The composition of the heat-activatable layer 20 is advantageously selected such that it may be removed cleanly from the surface during the wash-off process so that it will not significantly stain or leave deposits on the surface.

The label 100 may further comprise additives like fillers. The label 100 may further comprise additional layers, such as intermediate layers implemented between the heat-shrinkable layer 10 and the heat-activatable layer 20. The top side of the heat-shrinkable layer 10 may be optionally protected with one or more protective layers. The additional layers may be arranged to improve the label properties, functionality or appearance. Graphical patterns 30 may be printed on one or more of said layers e.g. in order to provide a visual effect and/or in order to display information.

The label 100 may be attached to the item ITE1 such that the label 100 does not completely surround the item ITE1. The label 100 may be attached to the item ITE1 such that the label 100 does not form a closed loop. In an embodiment, the label 100 does not form a closed loop. In an embodiment, the heat-shrinkable material of the label 100 does not form a closed loop.

The label 100 does not need to be a sleeve. Thus, for example, a large item may be labeled with a small label.

The label 100 may be attached to the item ITE1 such that the label 100 is not under tensile stress during cooling of the heat-activatable layer 20.

A typical method used for removing labels in North America may comprise e.g. using a washing liquid LIQ1, which contains 4.0 to 4.5% (by weight) sodium hydroxide dissolved in water, typically heated to a temperature T_{WASH} of 66° C. (i.e. about 150° F.).

The material of the heat-shrinkable layer 10 and the material of the heat-activatable layer 20 may be selected such that shrinking and softening of the bond can take place when the label is heated to a temperature higher than 60° C. The temperature of a washing liquid LIQ1 used for removing the label 100 may be e.g. higher than 60° C. The washing liquid LIQ1 may be e.g. an alkaline solution heated to a temperature, which is in the range of 60° C. to 85° C. The washing liquid LIQ1 may contain e.g. 0.5% to 10% (by weight) sodium hydroxide dissolved in water. A typical method for removing labels in Europe may comprise e.g. using a washing liquid LIQ1, which contains 1.5 to 2.0% (by weight) sodium hydroxide dissolved in water, typically heated to a temperature of about 80° C. Thus, the washing liquid LIQ1 may be e.g. an alkaline solution heated to a temperature T_{WASH}, which is in the range of 75° C. to 85° C. The washing liquid LIQ1 may contain e.g. 0.5% to 10% (by weight) sodium hydroxide dissolved in water.

The washing liquid LIQ1 used in the beverage industry may typically be alkaline. It may be advantageous to select the materials of the label such that the label can be easily removed by using the composition and temperature of the washing liquid, which are typically used in the beverage industry.

However, the washing liquid LIQ1 may also be substantially neutral. For example, the pH of the washing liquid LIQ1 may be e.g. in the range of 5 to 9. This may be applicable e.g. for removing a label from a re-usable aluminum container, which might be damaged in an alkaline solution.

The recycling of the materials of the label 100 may be facilitated if chemical composition of the heat-activatable layer 20 and/or the chemical composition of the washing liquid LIQ1 are selected such that the heat-activatable layer 20 is not dissolved in the heated washing liquid LIQ1.

The material of the adhesive layer 20 may be selected such that it is not significantly dissolved and/or chemically bound in the washing liquid LIQ1. Thus, the need to purify the washing liquid LIQ1 may be reduced.

The materials of the adhesive layer 20 may also be selected such that transformation from the non-tacky state to a tacky state is an irreversible process. In this case, the time delay between heating and contact with the item may be long.

When forming the adhesive layer 20, e.g. after applying a dispersion on a substrate (e.g. on the layer 10), the dispersion may be dried at temperatures low enough not to cause softening and/or melting of plasticizers. Therefore, the evaporation of water from the dispersion may produce a substantially non-tacky adhesive layer. Activation may be performed using a high temperature, which may cause the plasticizers to melt and make the adhesive permanently tacky. This transformation relates to lowering the glass transition temperature Tg of the adhesive. The materials of the layer 20 may be selected such that the plasticizers do not crystallize again even after lowering the temperature again and therefore this temperature switching from a non-tacky state to a tacky state may be an irreversible process. In particular, the transformation of an acrylate adhesive may be irreversible. After thermal activation, the adhesive may remain tacky even after cooling.

The heating may take place so fast that the temperature of the heat-shrinkable layer 10 remains lower than the threshold temperature T_{THR}. The light source 200 may be a laser, which is arranged to provide one or more laser beams LB1. The light source may be arranged to operate such that the intensity of the light LB1 is higher than a predetermined limit.

However, if the intensity is too high, the heat-activatable layer 20 may be damaged e.g. due to oxidation, chemical decomposition and/or ablation. The intensity may be kept below a second predetermined limit in order to avoid permanently damaging the heat-activatable layer 20.

The light source 200 providing the light LB1 may be e.g. a diode laser, by a carbon dioxide laser, by an argon-ion laser, or by a Nd:YAG-laser. One or more (laser) light beams LB1 may be used to heat the layer 20.

The intensity of the light beam LB1 may be higher than a predetermined limit such that the duration of heating can be kept shorter than a second predetermined limit, e.g. shorter than 100 ms, advantageously shorter than 20 ms. In case of a very thin label 100, the duration of heating may be kept e.g. shorter than 10 ms or even shorter than 1 ms (10⁻³ s). The intensity of the light beam LB1 at the exposed surface of the activatable layer 20 may be e.g. higher than 100 W/cm², advantageously higher than 500 W/cm². For example, the optical power of a laser beam LB1 may be e.g. in the range of 10 W to 200 W, and the optical power of said laser beam LB1 may be focused to a laser spot SP1 such that the intensity of the beam LB1 at the exposed surface of the activatable layer 20 is higher than 100 W/cm², advantageously higher than 500 W/cm².

The laser beam LB1 may be a continuous wave (CW) beam or a pulsed beam. The heating rate may also be controlled by adjusting the pulse frequency and/or duty cycle of the laser pulses.

A laser beam LB1 may rapidly activate the layer 20 such that the activated area is accurately defined. The laser beam LB1 may also have a peak wavelength, which matches with the spectral absorbance of the layer 20.

In an embodiment, the light LB1 may also be provided by a tungsten halogen lamp or by an infrared-emitting rod.

The whole (bottom) area of a label 100 may be heated substantially simultaneously. Alternatively, different portions of the label 100 may be heated at different times.

The labels 100 or the web 101 may be printed with any type of print process such as UV-flexo, UV-letterpress, water-based-flexo, solvent-based flexo, gravure, offset, screenprocess, thermal-transfer, direct-thermal hot- or cold-foil stamping. After printing, the labels may be die-cut and supplied in pre-cut form. The labels may have an arbitrary shape and/or design format.

The labels 100 may be supplied in rolls to an application point, where they may be cut using a laser or a die-cutting blade, and they may be transferred to e.g. a vacuum drum (FIG. 12a) or vacuum belt. The label 100 may be picked and transferred to desired location by using suction generated by the vacuum drum or belt.

The combination of the item ITE1 and the label 100 may be formed by heating a portion 21 of the heat-activatable layer 20 of the label 100 by visible or infrared light LB1 so that at least a portion of the surface of the heat-activatable layer 20 is converted from a non-tacky state to a tacky state, wherein the intensity of the light LB1 may be selected such that the temperature T₁₀ of a portion 11 of the heat-shrinkable layer 10 remains lower than the threshold shrinking temperature T_{THR} of the heat-shrinkable layer 10 during the heating by the light LB1. Said portion 11 may be located within the heat-shrinkable layer 10 such that the distance to the upper surface of the layer 10 is equal to the distance to the lower surface of the layer 10.

The item ITE1 may be attached to the item ITE1 such that the label 100 does not form a closed loop around the item ITE1. The item ITE1 may be attached to the item ITE1 such that the label 100 does not form a closed loop around the item ITE1 during activation of the heat-activatable layer 20 of the label 100 with the light LB1. The item ITE1 may be attached to the item ITE1 such that the heat-shrinkable material of the label 100 does not form a closed loop around the item ITE1. The item ITE1 may be attached to the item ITE1 such that the heat-shrinkable material of the label 100 does not form a closed loop around the item ITE1 during activation of the heat-activatable layer 20 of the label 100 with the light LB1. The heat-activatable layer 20 may be activated by heating with the light LB1 such that the label 100 does not form a closed loop around the item ITE1 when the layer 20 is in the tacky state. The combination of the label 100 and the item ITE1 may be formed such that the label 100 does not form a closed loop around the item ITE1 after a stable bond between the heat-activatable layer 20 and the surface of the item has been formed. The combination of the label 100 and the item ITE1 may be formed such that the label 100 does not form a closed loop around the item ITE1 when substantially the whole bottom area of the label 100 is in contact with the item ITE1. The combination of the label 100 and the item ITE1 may be formed such that the label 100 does not form a closed loop around the item ITE1 after the whole bottom area of the label 100 has been brought into contact with the item ITE1.

Various aspects of the invention are illustrated by the following examples:

### EXAMPLE 1

A method for attaching a label (100) to an item (ITE1), the label (100) comprising a heat-shrinkable layer (10) and a heat-activatable layer (20), the method comprising:
heating a portion (21) of the heat-activatable layer (20) by visible or infrared light (LB1) so that at least a portion of the surface of the heat-activatable layer (20) is converted from a non-tacky state to a tacky state, and
attaching the label (100) to the item (ITE1) when the surface of the heat-activatable layer (20) is in the tacky state,
   wherein the intensity of the light (LB1) is selected such that the temperature (T₁₀) of a portion (11) of the heat-shrinkable layer (10) remains lower than the threshold shrinking temperature (T_{THR}) of the heat-shrinkable layer (10).

### EXAMPLE 2

The method of claim 1 wherein the shrinkage capability of the heat-shrinkable layer (10) of the label (100) is greater than 20%.

### EXAMPLE 3

The method of claim 1 or 2 wherein the light (LB1) is a laser beam provided by a carbon dioxide laser (200).

### EXAMPLE 4

The method according to any of the claims 1 to 3 wherein the length of a time period between heating and bringing the portion (21) into contact with the item (ITE1) is shorter than 1 s, preferably shorter than 0.1 s.

### EXAMPLE 5

The method according to any of the claims 1 to 4 wherein the activation temperature (T_{ACT}) of the heat-activatable layer (20) is higher than the threshold shrinking temperature (T_{THR}) of the heat-shrinkable layer (10).

### EXAMPLE 6

The method according to any of the claims 1 to 5 further comprising separating the label (100) from the item (ITE1) by heating the label (100) to a temperature (T_{WASH}), which is higher than or equal to the threshold shrinking temperature (T_{THR}) of the heat-shrinkable layer (10), and which is higher than or equal to the activation temperature (T_{ACT}) of the heat-activatable layer (20).

### EXAMPLE 7

A label (100) comprising a heat-shrinkable layer (10) and a heat-activatable layer (20), wherein the activation temperature (T_{ACT}) of the heat-activatable layer (20) is higher than the threshold shrinking temperature (T_{THR}) of the heat-shrinkable layer (10).

### EXAMPLE 8

The label (100) of claim 7 wherein the shrinkage capability of the heat-shrinkable layer (10) of the label (100) is greater than 20%.

### EXAMPLE 9

The label (100) of claim 7 or 8 wherein the heat-activatable layer (20) comprises a polyurethane adhesive, and the heat-shrinkable layer (10) comprises polyethylene terephthalate (PET), glykol-modified polyethylene terephtalate (PETG) polyvinylchloride (PVC), polyester, polystyrene, polyethylene, polypropene, polyoefin, cyclicolefin copolymer, and/or polyactic acid (PLA).

### EXAMPLE 10

The label (100) according to any of the claims 7 to 9 comprising forming at least two heat-activatable regions (20a, 20b) such that a permanently passive region (22) remains between said two regions (20a, 20b).

### EXAMPLE 11

A method of manufacturing a label (100), the method comprising:
applying a dispersion onto a structure comprising a heat-shrinkable layer (10), and
drying the dispersion so as to form a solid non-tacky layer (20), which comprises a heat-activatable adhesive (ADH1),
   wherein the activation temperature (T_{ACT}) of the heat-activatable layer (20) is higher than the threshold shrinking temperature (T_{THR}) of the heat-shrinkable layer (10).

### EXAMPLE 12

A combination of an item (ITE1) and label (100) attached to the item (ITE1), the label (100) comprising a heat-shrinkable layer (10) and a heat-activatable layer (20), wherein the activation temperature (T_{ACT}) of the heat-activatable layer (20) is higher than the threshold shrinking temperature (T_{THR}) of the heat-shrinkable layer (10).

### EXAMPLE 13

The combination of claim 12 wherein the shrinkage capability of the heat-shrinkable layer (10) of the label (100) is greater than 20%.

### EXAMPLE 14

The combination of claim 11 or 12 wherein the item (ITE1) is a glass bottle.

### EXAMPLE 15

A method of separating a label (100) from an item (ITE1), the label (100) comprising a heat-shrinkable layer (10) and a heat-activatable layer (20), the method comprising:
heating the label (100) to a temperature (T_{WASH}), which is higher than or equal to the threshold shrinking temperature (T_{THR}) of the heat-shrinkable layer (10), and which is higher than or equal to the activation temperature (T_{ACT}) of the heat-activatable layer (20).

### EXAMPLE 16

The method of claim 15 wherein the activation temperature (T_{ACT}) of the heat-activatable layer (20) is higher than the threshold shrinking temperature (T_{THR}) of the heat-shrinkable layer (10).

### EXAMPLE 17

The method of claim 15 or 16 comprising immersing the label (100) in a heated washing liquid (LIQ1).

### EXAMPLE 18

An apparatus (500) for attaching a label (100) to an item (ITE1), the label (100) comprising a heat-shrinkable layer (10) and a heat-activatable layer (20), the apparatus comprising:
a light source (200) arranged to heat a portion (21) of the heat-activatable layer (20) by visible or infrared light (LB1) so as to transform the surface of the heat-activatable layer (20) from a non-tacky state to a tacky state, and
a holding member (310, 320) arranged to attach said portion (21) to the item (ITE1) when the surface of the heat-activatable layer (20) is in the tacky state,
   wherein the light source (200) and the holding member (310, 320) are arranged to operate such that a temperature (T₁₀) of a portion (11) of the heat-shrinkable layer (10) remains lower than the threshold shrinking temperature (T_{THR}) of the heat-shrinkable layer (10) during the time period between the heating and the attaching.

For the person skilled in the art, it will be clear that modifications and variations of the devices and the methods according to the present invention are perceivable. The drawings are schematic. The particular embodiments described above with reference to the accompanying drawings are illustrative only and not meant to limit the scope of the invention, which is defined by the appended claims.

1-12. (canceled)

13. A method for attaching a label to an item, the label comprising a heat-shrinkable layer and a heat-activatable layer, wherein the activation temperature of the heat activatable layer is higher than the threshold shrinking temperature of the heat-shrinkable layer, wherein the method comprises:
heating a portion of the heat-activatable layer by visible or infrared light so that at least a portion of the surface of the heat-activatable layer is converted from a non-tacky state to a tacky state, and
attaching the label to the item when the surface of the heat-activatable layer is in the tacky state,
wherein the intensity of the light is selected such that the temperature of a portion of the heat-shrinkable layer remains lower than the threshold shrinking temperature of the heat-shrinkable layer.

14. The method of claim 13 wherein the shrinkage capability of the heat-shrinkable layer of the label is greater than 20%.

15. The method of claim 13 wherein the light is a laser beam provided by a carbon dioxide laser.

16. The method according to claim 13 wherein the length of a time period between heating and bringing the portion into contact with the item is shorter than 1 s.

17. The method according to claim 13 wherein the length of a time period between heating and bringing the portion into contact with the item is shorter than 0.1 s.

18. The method according to claim 13 further comprising separating the label from the item by heating the label to a temperature, which is higher than or equal to the threshold shrinking temperature of the heat-shrinkable layer, and which is higher than or equal to the activation temperature of the heat-activatable layer.

19. The method according to claim 13 wherein the label is attached to the item such that the label does not completely surround the item.

20. A combination of an item and label attached to the item, the label comprising a heat-shrinkable layer and a heat-activatable layer, wherein the activation temperature of the heat-activatable layer is higher than the threshold shrinking temperature of the heat-shrinkable layer, wherein the label has been attached to the item by heating a portion of the heat-activatable layer by visible or infrared light so that at least a portion of the surface of the heat-activatable layer has been converted from a non-tacky state to a tacky state, wherein the intensity of the light has been selected such that the temperature of a portion of the heat-shrinkable layer has remained lower than the threshold shrinking temperature of the heat-shrinkable layer during the heating.

21. The combination of claim 20 wherein the shrinkage capability of the heat-shrinkable layer of the label is greater than 20%.

22. The combination of claim 20 wherein the item is a glass bottle.

23. The combination according to claim 20 wherein the label is attached to the item such that the label does not completely surround the item.

24. A method of separating a label from an item, wherein the label comprises a heat-shrinkable layer and a heat-activatable layer, the activation temperature of the heat-activatable layer is higher than the threshold shrinking temperature of the heat-shrinkable layer, the label has been attached to the item by heating a portion of the heat-activatable layer by visible or infrared light so that at least a portion of the surface of the heat-activatable layer has been converted from a non-tacky state to a tacky state, and the intensity of the light has been selected such that the temperature of a portion of the heat-shrinkable layer has remained lower than the threshold shrinking temperature of the heat-shrinkable layer during the heating, the method comprising:
heating the label to a temperature, which is higher than or equal to the threshold shrinking temperature of the heat-shrinkable layer, and which is higher than or equal to the activation temperature of the heat-activatable layer.

25. The method of claim 24 comprising immersing the label in a heated washing liquid.
